(19) United States
(12) Patent Application Publication
(10) Pub. No.: US 2015/0314314 A1
(43) Pub. Date: Nov. 5, 2015

(54) SUBSTRATE PROCESSING APPARATUS AND SUBSTRATE PROCESSING METHOD

(71) Applicant: SCREEN Holdings Co., Ltd., Kyoto (JP)

(72) Inventor: Joji KUWAHARA, Kyoto-shi (JP)

(21) Appl. No.: 14/697,675

(22) Filed: Apr. 28, 2015

(30) Foreign Application Priority Data
Apr. 30, 2014 (JP) 2014-094150

(51) Int. Cl. B05B 12/12; B08B 3/02; B05C 13/00

(52) U.S. Cl. CPC B05B 12/122; B05C 13/00; B08B 3/02

(57) ABSTRACT

A rotation holding device is rotated about a rotation axis, and a controller calculates a rotation direction offset amount, an X offset amount and a Y offset amount based on position data that is acquired from a line sensor. An X direction movable portion and a Y direction movable portion are moved such that the X offset amount and the Y offset amount become 0, and the rotation holding device is rotated such that the rotation direction offset amount becomes 0. A film thickness measurement device sequentially measures the thickness of a film on a substrate while the X direction movable portion is moved in an X direction.

### BACKGROUND OF THE INVENTION

1. Field of the Invention

The present invention relates to a substrate processing apparatus and a substrate processing method for performing processing on a substrate.

2. Description of Related Art

Substrate processing apparatuses are used to subject various types of substrates such as semiconductor substrates, substrates for liquid crystal displays, plasma displays, optical disks, magnetic disks, magneto-optical disks, and photomasks, and other substrates to various types of processing.

In a substrate processing apparatus described in JP 2003-151893 A, a periphery exposure function of performing exposure on a peripheral region (a peripheral portion) of a resist film on a substrate and a substrate processing unit that has a film thickness measurement function of measuring a thickness of the resist film on the substrate are provided. The substrate processing unit includes an exposure head and a film thickness measurement device. The exposure head and the film thickness measurement device are provided to be movable in X and Y directions by an XY driving mechanism.

During an exposure operation, the substrate held by a spin chuck is rotated, and the distance from a rotation axis of the spin chuck to an outer periphery of the substrate is detected by an edge sensor. A positional relationship between a center of the substrate and the rotation axis of the spin chuck, and a position of the substrate with respect to the spin chuck are detected based on the result of detection. Thus, a position of a peripheral region, of the substrate, to be exposed is specified. A position irradiated with light for exposure by the exposure head is changed by the XY driving mechanism while the substrate held by the spin chuck is rotated, whereby the exposure for the peripheral region of the substrate is performed.

During a film thickness measurement operation, the substrate held by the spin chuck is rotated and the distance from the rotation axis of the spin chuck to the outer periphery of the substrate is detected by the edge sensor. The positional relationship between the center of the substrate and the rotation axis of the spin chuck, and the position of the substrate with respect to the spin chuck are detected based on the result of detection. Thus, a position of a measurement point, of the substrate, to be measured is specified. An optical head of the exposure head of the film thickness measurement device is moved to a position corresponding to the measurement point of the substrate by the XY driving mechanism, whereby the film thickness at the measurement point is measured.

It is required that the number of chips that are acquired from one substrate is increased. Therefore, it is necessary that processing such as exposure on the peripheral portion of the substrate and the like is performed with high accuracy.

In the processing unit described in JP 2003-151893 A, even when the center of the substrate deviates from the rotation axis of the spin chuck, the processing such as the exposure can be performed on the peripheral portion of the substrate.

However, when processing is performed in a specific region of the substrate with the substrate being eccentric, there is a limit to accuracy of the processing. For example, when processing is performed in a region, having a constant angle, at the peripheral portion of the substrate with the center of the substrate deviating from a rotational center, the positions of a start point and a finish point of the processing are likely to deviate from each other. Therefore, it is desirable that the processing is performed in the specific region of the substrate with the center of the substrate coinciding with the rotational center.

In a substrate processing apparatus described in JP 2008-60302 A, two guide arms are provided in each of a plurality of coating units in order to accurately remove a film formed on the peripheral portion of a substrate. In each coating unit, with the substrate that is carried in from outside being placed on a spin chuck, the two guard arms are moved towards an axial center on the spin chuck. The substrate is held by the two guide arms on the spin chuck, so that a position of the substrate is corrected on the spin chuck. In this state, the substrate is held by suction by the spin chuck. Thereafter, a coating liquid is supplied to the substrate held by the spin chuck, and the film is formed on the substrate. Subsequently, a removal liquid is supplied to the peripheral portion of the substrate from a needle-shaped nozzle. Thus, the portion of the film formed on the peripheral portion of the substrate is removed.

### BRIEF SUMMARY OF THE INVENTION

However, in the configuration that is described in the above-mentioned JP 2008-60302 A, the guide arms come into contact with the outer peripheral end of the substrate. Therefore, particles may be generated due to stripping of the film that is formed at the end of the substrate. Therefore, it is desired that the position of the substrate is adjusted to a predetermined position without contact with the end of the substrate.

An object of the present invention is to provide a substrate processing apparatus and a substrate processing method capable of highly accurately aligning a substrate without contact with an end of the substrate.

(1) A substrate processing apparatus according to one aspect of the present invention that performs processing on a substrate includes a rotation holding device that holds the substrate and rotates the substrate about a rotation axis, a moving device that moves the rotation holding device in a two-dimensional direction that is orthogonal to the rotation axis, a position detector that detects a position of an outer periphery of the substrate rotated by the rotation holding device and a controller that controls the moving device based on the position detected by the position detector such that a center of the substrate held by the rotation holding device coincides with a predetermined reference axis.

In the substrate processing apparatus, the position of the outer periphery of the substrate rotated by the rotation holding device is detected by the position detector, and the rotation holding device is moved in the two-dimensional direction by the moving device based on the detected position such that the center of the substrate held by the rotation holding member coincides with the predetermined reference axis. Thus, the substrate can be highly accurately aligned without contact with the end of the substrate.

(2) The controller may calculate an amount of deviation between the center of the substrate held by the rotation holding device and the rotation axis of the rotation holding device based on the position detected by the position detector, and may control the moving device based on the calculated amount of deviation such that the center of the substrate held by the rotation holding device coincides with the reference axis.

In this case, even when the center of the substrate held by the rotation holding device deviates from the rotation axis of the rotation holding device, the center of the substrate can coincide with the reference axis.

(3) The controller may calculate a direction of a notch of the substrate held by the rotation holding device based on the position detected by the position detector, and may control the rotation holding device and the moving device based on the calculated direction such that the direction of the notch of the substrate held by the rotation holding device coincides with a predetermined reference direction.

In this case, even when the direction of the notch of the substrate held by the rotation holding device does not coincide with the reference direction, the direction of the notch of the substrate can coincide with the reference direction.

(4) The controller may control the moving device based on the calculated amount of deviation such that the center of the substrate held by the rotation holding device coincides with a predetermined measurement position, may control the rotation holding device and the moving device such that the substrate is rotated with the center of the substrate held by the rotation holding device coinciding with the measurement position, may calculate a direction of a notch of the substrate with the center of the substrate coinciding with the measurement position based on the position detected by the position detector, and may control the rotation holding device and the moving device based on the calculated direction such that the direction of the notch of the substrate held by the rotation holding device coincides with a predetermined reference direction.

In this case, the direction of the notch of the substrate is calculated with the center of the substrate held by the rotation holding device coinciding with the measurement position. Thus, the direction of the notch is accurately calculated. Therefore, the direction of the notch of the substrate can accurately coincide with the reference direction.

(5) The controller may control the rotation holding device and the moving device such that the rotation holding device rotates the substrate about the rotation axis while the moving device moves the rotation holding device to keep the center of the rotated substrate coinciding with the reference axis.

In this case, even when the center of the substrate held by the rotation holding device deviates from the rotation axis of the rotation holding device, the substrate can be rotated with the center of the substrate coinciding with a rotational center.

(6) The substrate processing apparatus may further include a lifting lowering mechanism that moves the substrate away from the rotation holding device to support the substrate above the rotation holding device after the center of the substrate held by the rotation holding device coincides with the reference axis, wherein the controller may control the moving device such that the rotation axis of the rotation holding device coincides with the center of the substrate when the substrate is supported by the lifting lowering mechanism, the lifting lowering mechanism may lower the substrate after the rotation axis of the rotation holding device coincides with the center of the substrate, and the rotation holding device may hold the substrate that is lowered by the lifting lowering mechanism and may rotate the substrate about the rotation axis.

In this case, even when the center of the substrate held by the rotation holding device deviates from the rotation axis of the rotation holding device, the substrate is arranged again by the rotation holding device such that the center of the substrate coincides with the rotation axis of the rotation holding device by a simple operation of the lifting lowering mechanism. Thus, the substrate can be rotated with the center of the substrate coinciding with the rotational center without movement of the rotation holding device in the two-dimensional direction by the moving device.

(7) The substrate processing apparatus may further include a first processor that performs processing on a peripheral portion of an upper surface of the substrate rotated by the rotation holding device.

In this case, because the substrate is rotated with the center of the substrate coinciding with the rotational center, the processing can be accurately performed in a region, having a constant width, at the peripheral portion of the upper surface of the substrate.

(8) The substrate processing apparatus may further include a second processor that performs processing on an outer peripheral end of the substrate rotated by the rotation holding device.

In this case, because the substrate is rotated with the center of the substrate coinciding with the rotational center, the processing can be uniformly performed on the outer peripheral end of the substrate.

(9) The substrate processing apparatus may further include a measurement device that measures a condition at a predetermined position of the substrate, wherein the controller may move the substrate held by the rotation holding device by controlling at least one of the rotation holding device and the moving device after the center of the substrate held by the rotation holding device coincides with the reference axis such that the condition at the predetermined position is measured by the measurement device.

In this case, because the substrate is moved after the center of the substrate coincides with the reference axis, the condition at the predetermined position of the substrate can be accurately measured.

(10) A substrate processing apparatus according to another aspect of the present invention that performs processing on a substrate may include a rotation holding device that holds the substrate in a horizontal attitude and rotates the substrate about a rotation axis, a transport mechanism that transports the substrate to the rotation holding device such that a center of the substrate deviates from the rotation axis of the rotation holding device, a moving device that moves the rotation holding device in a two-dimensional direction that is orthogonal to the rotation axis, a position detector that detects a position of an outer periphery of the substrate rotated by the rotation holding device, a substrate holder that holds the substrate in the horizontal attitude and has a reference axis in a vertical direction, and a controller that controls the moving direction and the rotation holding device such that the rotation holding device transfers the substrate to the substrate holder, wherein the controller may control the rotation holding device and the moving device based on the position detected by the position detector such that the center of the transferred substrate coincides with the reference axis of the substrate holder.

In this substrate processing apparatus, the substrate is transported to the rotation holding device by the transport mechanism such that the center of the substrate deviates from the rotation axis of the rotation holding device. In this state, the substrate is held in the horizontal attitude and is rotated about the rotation axis by the rotation holding device, and the position of the outer periphery of the substrate that is rotated is detected. Thereafter, the substrate is transferred from the rotation holding device to the substrate holder. At this time, the rotation holding device is moved in the two-dimensional direction by the moving device based on the position of the outer periphery detected as described above such that the center of the transferred substrate coincides with the reference axis of the substrate holder. The transferred substrate is held by the substrate holder in the horizontal attitude.

Thus, the substrate is held by the substrate holder with the center of the substrate coinciding with the reference axis. Therefore, the substrate can be highly accurately aligned without contact with the end of the substrate.

(11) An assumption position that deviates from the rotation axis of the rotation holding device may be set in advance, and the controller may calculate an amount of deviation between the center of the substrate held by the rotation holding device and the assumption position based on the position detected by the position detector, and may control the moving device based on the calculated amount of deviation such that the center of the transferred substrate coincides with the reference axis of the substrate holder.

In this case, even when the center of the substrate held by the rotation holding device deviates from the rotation axis of the rotation holding device, the center of the substrate can coincide with the reference axis of the substrate supporter.

(12) The controller may calculate a direction of a notch of the substrate held by the rotation holding device based on the position detected by the position detector, and may control the rotation holding device and the moving device based on the calculated direction such that the direction of the notch of the transferred substrate coincides with a predetermined reference direction.

In this case, even when the center of the substrate held by the rotation holding device deviates from the rotation axis of the rotation holding device, the center of the substrate can coincide with the reference direction in the substrate supporter.

(13) The substrate holder may be configured to hold the substrate in the horizontal attitude and rotate the substrate about the reference axis.

In this case, the substrate can be rotated with the center of the substrate coinciding with the reference axis in the substrate supporter.

(14) The substrate processing apparatus may further include a first processor that performs processing on a peripheral portion of an upper surface of the substrate rotated by the substrate holder.

In this case, because the substrate is rotated with the center of the substrate coinciding with the rotational center, the processing can be accurately performed in the region, having the constant width, at the peripheral portion of the upper surface of the substrate.

(15) The substrate processing apparatus may further include a second processor that performs processing on an outer peripheral end of the substrate rotated by the substrate holder.

In this case, because the substrate is rotated with the center of the substrate coinciding with the rotational center, the processing can be uniformly performed on the peripheral end of the substrate.

(16) A substrate processing method according to yet another aspect of the present invention for performing processing on a substrate includes the steps of holding and rotating the substrate about a rotation axis by a rotation holding device, detecting a position of an outer periphery of the substrate rotated by the rotation holding device, and moving the rotation holding device in a two-dimensional direction that is orthogonal to the rotation axis based on the detected position such that a center of the substrate held by the rotation holding device coincides with a predetermined reference axis.

In the substrate processing method, the position of the outer periphery of the substrate rotated by the rotation holding device is detected, and the rotation holding device is moved in the two-dimensional direction by the moving device based on the detected position such that the center of the substrate held by the rotation holding device coincides with the predetermined reference axis. Thus, the substrate can be highly accurately aligned without contact with the end of the substrate.

(17) A substrate processing method according to yet another aspect of the present invention for performing processing on a substrate includes the steps of transporting the substrate to a rotation holding device by a transport mechanism such that a center of the substrate deviates from a rotation axis of the rotation holding device, holding the substrate in a horizontal attitude and rotating the substrate about the rotation axis by the rotation holding device, detecting a position of an outer periphery of the substrate rotated by the rotation holding device, transferring the substrate from the rotation holding device to the substrate holder, and holding the transferred substrate in the horizontal attitude by the substrate holder, wherein the step of transferring includes moving the rotation holding device in a two-dimensional direction that is orthogonal to the rotation axis by a moving device based on the detected position such that the center of the transferred substrate coincides with the reference axis of the substrate holder.

In this substrate processing method, the substrate is transported to the rotation holding device by the transport mechanism such that the center of the substrate deviates from the rotation axis of the rotation holding device. In this state, the substrate is held in the horizontal attitude and is rotated about the rotation axis by the rotation holding device, and the position of the outer periphery of the substrate that is rotated is detected. Thereafter, the substrate is transferred from the rotation holding device to the substrate holder. At this time, the rotation holding device is moved in the two-dimensional direction by the moving device based on the position of the outer periphery detected as described above such that the center of the transferred substrate coincides with the reference axis of the substrate holder. The transferred substrate is held in the horizontal attitude by the substrate holder.

Thus, the substrate is held by the substrate holder with the center of the substrate coinciding with the reference axis. Therefore, the substrate can be highly accurately aligned without contact with the end of the substrate.

Other features, elements, characteristics, and advantages of the present invention will become more apparent from the following description of preferred embodiments of the present invention with reference to the attached drawings.

### BRIEF DESCRIPTION OF THE SEVERAL VIEWS OF THE DRAWING

FIG. 1 is a schematic plan view showing a configuration of a substrate processing apparatus;

FIG. 2 is a schematic side view of the substrate processing apparatus mainly showing a coating processing section, a development processing section and a cleaning drying processing section of FIG. 1;

FIG. 3 is a schematic side view of the substrate processing apparatus mainly showing a thermal processing section and the cleaning drying processing section of FIG. 1;

FIG. 4 is a side view mainly showing a transport section of FIG. 1;

FIGS. 5A and 5B are a schematic plan view and a schematic side view showing a configuration of an edge exposure unit;

FIG. 6 is a block diagram showing a configuration of a control system of the edge exposure unit;

FIGS. 7A and 7B are schematic diagrams for explaining an operation of the edge exposure unit of FIGS. 5A and 5B;

FIGS. 8A to 8C are schematic diagrams for explaining the operation of the edge exposure unit of FIGS. 5A and 5B;

FIGS. 9A and 9B are schematic diagrams for explaining the operation of the edge exposure unit of FIGS. 5A and 5B; FIGS. 10A and 10B are schematic diagrams for explaining the operation of the edge exposure unit of FIGS. 5A and 5B;

FIGS. 11A and 11B are schematic diagrams for explaining the operation of the edge exposure unit of FIGS. 5A and 5B;

FIGS. 12A and 12B are schematic diagrams for explaining the operation of the edge exposure unit of FIGS. 5A and 5B;

FIG. 13 is a diagram showing one example of position data that is acquired based on output signals of a line sensor;

FIGS. 14A and 14B are schematic plan views showing one example of a film thickness measurement method by a film thickness measurement device;

FIGS. 15A and 15B are schematic plan views showing another example of the film thickness measurement method by the film thickness measurement device;

FIGS. 16A and 16B are schematic plan views showing an edge exposure method for a substrate by an exposure unit;

FIGS. 17A and 17B are a schematic plan view and a schematic side view showing a configuration of a first example of a coating processing unit;

FIG. 18 is a block diagram showing a configuration of a control system of the coating processing unit;

FIGS. 19A and 19B are a schematic plan view and a schematic side view for explaining an operation of the coating processing unit of FIGS. 17A and 17B;

FIGS. 20A and 20B are a schematic plan view and a schematic side view for explaining the operation of the coating processing unit of FIGS. 17A and 17B;

FIGS. 21A and 21B are a schematic plan view and a schematic side view for explaining the operation of the coating processing unit of FIGS. 17A and 17B;

FIGS. 22A and 22B are a schematic plan view and a schematic side view for explaining the operation of the coating processing unit of FIGS. 17A and 17B;

FIGS. 23A and 23B are a schematic plan view and a schematic side view showing a configuration of a second example of the coating processing unit;

FIG. 24 is a schematic plan view showing an operation of a moving device of the coating processing unit of FIGS. 23A and 23B;

FIGS. 25A and 25B are a schematic plan view and a schematic side view showing a configuration of a third example of the coating processing unit;

FIGS. 26A and 26B are schematic plan views showing the operation of the moving device of the coating processing unit of FIGS. 25A and 25B;

FIGS. 27A and 27B are schematic plan views showing the operation of the moving device of the coating processing unit of FIGS. 25A and 25B;

FIGS. 28A and 28B are schematic plan views showing the operation of the moving device of the coating processing unit of FIGS. 25A and 25B;

FIGS. 29A and 29B are a schematic plan view and a schematic side view showing a configuration of an example of a substrate platform;

FIGS. 30A and 30B are a schematic plan view and a schematic side view showing a configuration of a first example of a cleaning drying processing unit;

FIGS. 31A and 31B are a schematic side view and a schematic plan view showing a configuration of a second example of the cleaning drying processing unit;

FIGS. 32A to 32C are schematic diagrams for explaining an operation of the cleaning drying processing unit;

FIGS. 33A and 33B are schematic diagrams for explaining the operation of the cleaning drying processing unit;

FIGS. 34A to 34E are schematic plan views showing a configuration and an operation of a main portion of a transport mechanism that is used as a moving device;

FIG. 35 is a schematic plan view showing a configuration for adjusting an origin position when an incremental encoder is used; and

FIGS. 36A to 36E are schematic plan views for explaining an adjustment method of the origin position when the incremental encoder is used.

### DESCRIPTION OF THE PREFERRED EMBODIMENTS

A substrate processing apparatus according to embodiments of the present invention will be described with reference to the drawings. In the following description, a substrate refers to a semiconductor substrate, a substrate for a liquid crystal display, a substrate for a plasma display, a glass substrate for a photomask, a substrate for an optical disk, a substrate for a magnetic disk, a substrate for a magneto-optical disk, a substrate for a photomask or the like.

### (1) Overall Configuration

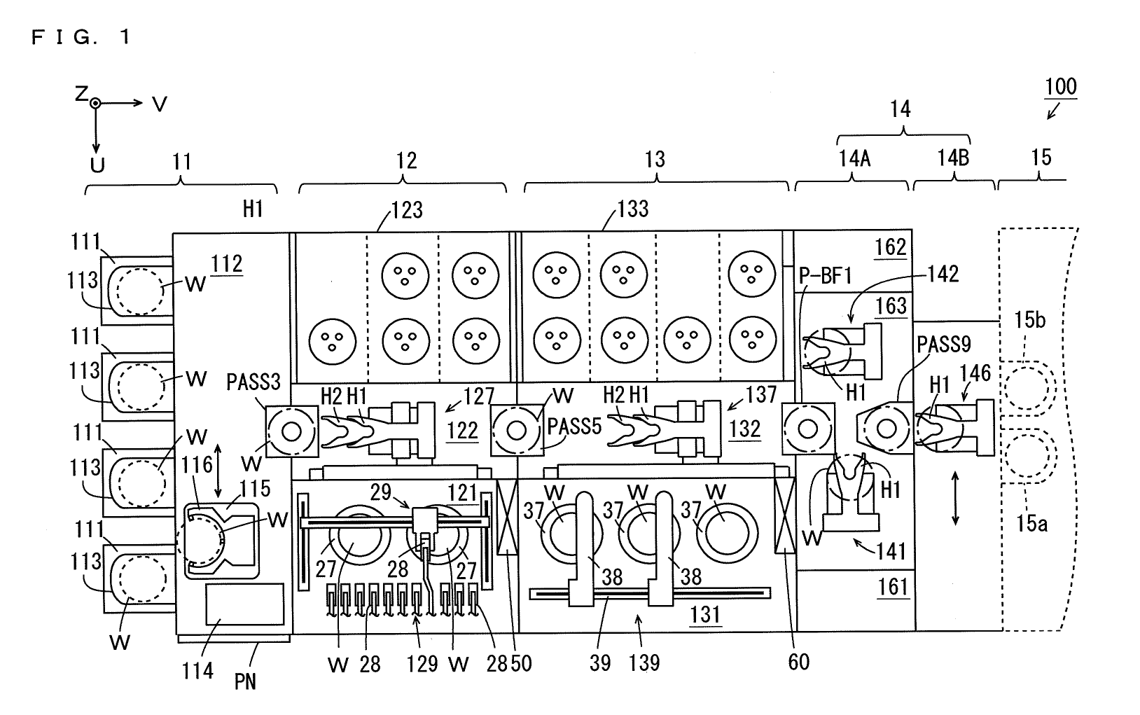

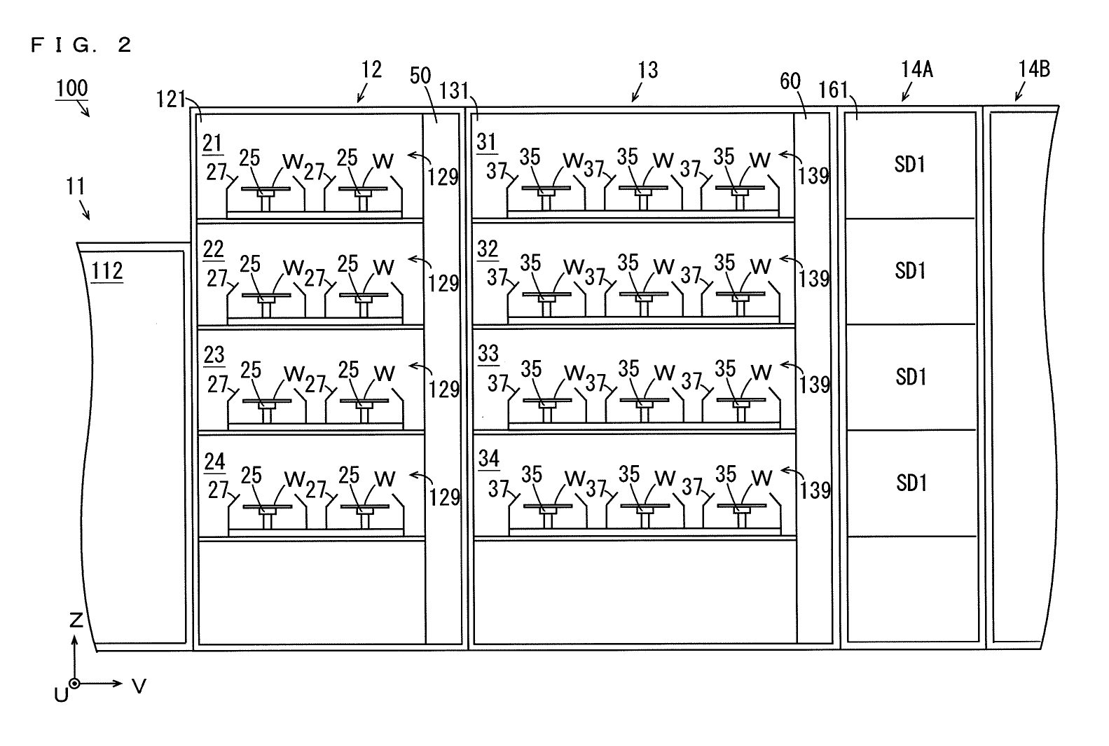

FIG. 1 is a schematic plan view showing a configuration of the substrate processing apparatus 100. FIG. 1 and subsequently given FIGS. 2 to 4 are accompanied by arrows that indicate U, V, and Z directions orthogonal to one another for clarity of a positional relationship. The U and V directions are orthogonal to each other within a horizontal plane, and the Z direction corresponds to a vertical direction.

As shown in FIG. 1, the substrate processing apparatus 100 includes an indexer block 11, a first processing block 12, a second processing block 13, a cleaning drying processing block 14A and a carry-in carry-out block 14B. An interface block 14 is constituted by the cleaning drying processing block 14A and the carry-in carry-out block 14B. An exposure device 15 is arranged to be adjacent to the carry-in carry-out block 14B. In the exposure device 15, exposure processing is performed on the substrate W using a liquid immersion method.

The indexer block 11 includes a plurality of carrier platforms 111 and a transport section 112. In each carrier platform 111, a carrier 113 for storing a plurality of substrates W in multiple stages is placed.

A controller 114 and a transport mechanism 115 are provided in the transport section 112. The controller 114 controls various constituent elements of the substrate processing apparatus 100. The transport mechanism 115 has a hand 116 for holding the substrate W. The transport mechanism 115 holds the substrate W using the hand 116 and transports the substrate W.

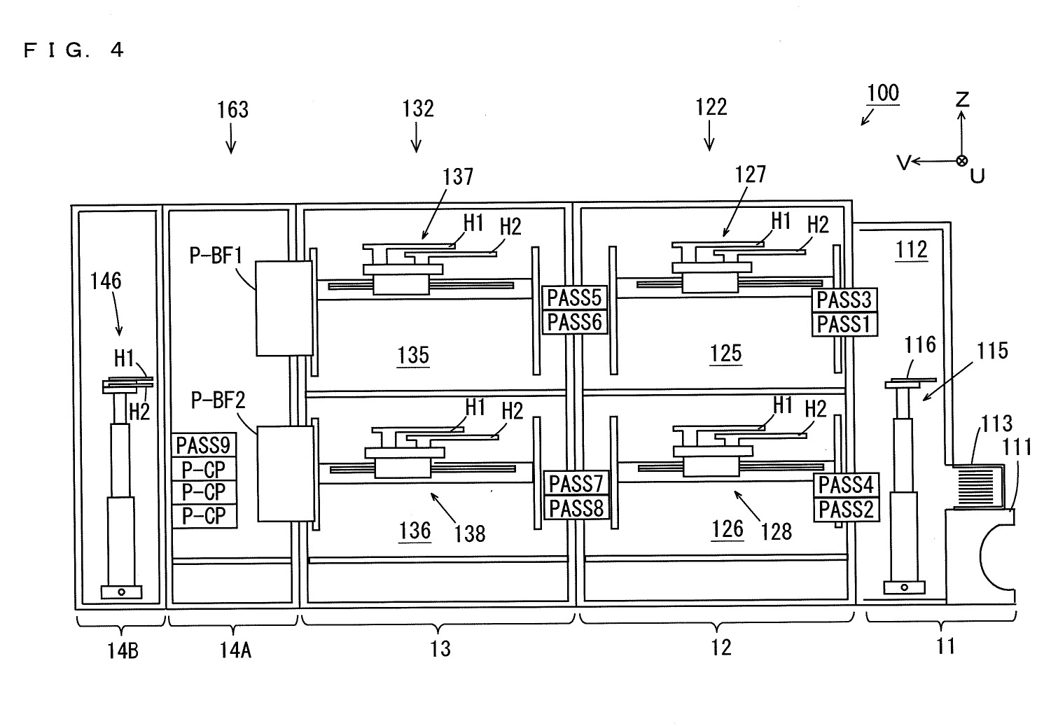

The first processing block 12 includes a coating processing section 121, a transport section 122 and a thermal processing section 123. The coating processing section 121 and the thermal processing section 123 are provided to be opposite to each other with the transport section 122 sandwiched therebetween. As described below, substrate platforms PASS1, PASS2, PASS3, PASS4 (see FIG. 4) on which the substrates W are placed are provided between the transport section 122 and the transport section 112. In the present embodiment, the substrate platforms PASS1 to PASS4 have an alignment function for the substrate W. The alignment for the substrate W refers to arranging a direction of a notch formed at the substrate W to coincide with a specific direction with respect to a center of the substrate W and the center of the substrate W to coincide with a specific position. Details of the substrate platforms PASS1 to PASS4 will be described below. A transport mechanism 127 and a transport mechanism 128 (see FIG. 4) that is described below, which transport the substrates W, are provided in the transport section 122.

The second processing block 13 includes a development processing section 131, a transport section 132 and a thermal processing section 133. The development processing section 131 and the thermal processing section 133 are provided to be opposite to each other with the transport section 132 sandwiched therebetween. Substrate platforms PASS5 to PASS8 (see FIG. 4) on which the substrates W are placed are provided between the transport section 132 and the transport section 122. A transport mechanism 137 and a transport mechanism 138 (see FIG. 4) that is described below, which transport the substrates W, are provided in the transport section 132.

The cleaning drying processing block 14A includes cleaning drying processing sections 161, 162 and a transport section 163. The cleaning drying processing sections 161, 162 are provided to be opposite to each other with the transport section 163 sandwiched therebetween. Transport mechanisms 141, 142 are provided in the transport section 163. A placement buffer unit P-BF1 and a placement buffer unit P-BF2 (see FIG. 4) that is described below are provided between the transport section 163 and the transport section 132. The placement buffer units P-BF1, P-BF2 are configured to be capable of storing the plurality of substrates W.

Further, a substrate platform PASS9 and a placement cooling platform P-CP (see FIG. 4) that is described below are provided to be adjacent to the carry-in carry-out block 14B between the transport mechanisms 141, 142. The placement cooling platform P-CP includes a function of cooling the substrate W. In the placement cooling platform P-CP, the substrate W is cooled to a temperature suitable for the exposure processing.

A transport mechanism 146 is provided in the carry-in carry-out block 14B. The transport mechanism 146 carries in the substrate W to and carries out the substrate W from the exposure device 15. A substrate inlet 15a for carrying in the substrate W and a substrate outlet 15b for carrying out the substrate W are provided at the exposure device 15.

### (2) Configuration of Coating Processing Section and Development Processing Section

FIG. 2 is a schematic side view of the substrate processing apparatus 100 mainly showing the coating processing section 121, the development processing section 131 and the cleaning drying processing section 161 of FIG. 1.

As shown in FIG. 2, in the coating processing section 121, coating processing chambers 21, 22, 23, 24 are provided in a stack. In the development processing section 131, development processing chambers 31, 32, 33, 34 are provided in a stack. In each of the coating processing chambers 21 to 24, a coating processing unit 129 is provided. In each of the development processing chambers 31 to 34, a development processing unit 139 is provided.

Each coating processing unit 129 includes spin chucks 25 that hold the substrates W and cups 27 provided to cover the surroundings of the spin chucks 25. In the present embodiment, two pairs of the spin chucks 25 and the cups 27 are provided at each coating processing unit 129. Each spin chucks 25 is driven to be rotated by a driving device that is not shown (an electric motor, for example). Further, as shown in FIG. 1, each coating processing unit 129 includes a plurality of processing liquid nozzles 28 that discharge a processing liquid and a nozzle transport mechanism 29 that moves these processing liquid nozzles 28.

In the coating processing unit 129, the spin chuck 25 is rotated by the driving device (not shown), any one of the plurality of processing liquid nozzles 28 is moved to a position above the substrate W by the nozzle transport mechanism 29, and a processing liquid is discharged from the processing liquid nozzle 28. Thus, the processing liquid is applied to an upper surface of the substrate W. Further, a rinse liquid is discharged at a peripheral portion of the substrate W from an edge rinse nozzle (not shown). Thus, the processing liquid adhering to the peripheral portion of the substrate W is removed. In the present embodiment, each coating processing unit 129 has the alignment function for the substrate W. Details of the coating processing unit 129 will be described below.

In the coating processing unit 129 in the coating processing chamber 22, 24, a processing liquid for an anti-reflection film is supplied to the substrate W from the processing liquid nozzle 28. In the coating processing unit 129 in the coating processing chamber 21, 23, a processing liquid for a resist film (hereinafter referred to as a resist liquid) is supplied to the substrate W from the processing liquid nozzle 28.

Each development processing unit 139 includes spin chucks 35 and cups 37 similarly to the coating processing unit 129. In the present embodiment, three pairs of the spin chucks 35 and the cups 37 are provided in each development processing unit 139. Each spin chuck 35 is driven to be rotated by a driving device that is not shown (an electric motor, for example). Further, as shown in FIG. 1, the development processing unit 139 includes two development nozzles 38 that discharge a development liquid and a moving mechanism 39 that moves the development nozzles 38 in the V direction.

In the development processing unit 139, the spin chuck 35 is rotated by the driving device (not shown) and the one development nozzle 38 supplies the development liquid to each substrate W while moving in the V direction. Thereafter, the other development nozzle 38 supplies the development liquid to each substrate W while moving. In this case, the development liquid is supplied to the substrate W, so that development processing for the substrate W is performed. Further, in the present embodiment, development liquids that are different from each other are discharged from the two development nozzles 38. Thus, two types of the development liquids can be supplied to each substrate W.

A plurality (four in the present example) of cleaning drying processing units SD1 are provided in the cleaning drying processing section 161. In each cleaning drying processing unit SD1, cleaning and drying processing for the substrate W before the exposure processing are performed. In the present embodiment, the cleaning drying processing unit SD1 has the alignment function for the substrate W. Details of the cleaning drying processing unit SD1 will be described below.

As shown in FIGS. 1 and 2, a fluid box 50 is provided in the coating processing section 121 to be adjacent to the development processing section 131. Similarly, a fluid box 60 is provided in the development processing section 131 to be adjacent to the cleaning drying processing block 14A. The fluid box 50 and the fluid box 60 each house fluid related elements such as pipes, joints, valves, flowmeters, regulators, pumps and temperature adjusters used to supply a chemical liquid to the coating processing units 129 and the development processing units 139 and discharge the liquid and air out of the coating processing units 129 and the development processing units 139.

### (3) Configuration of Thermal Processing Sections

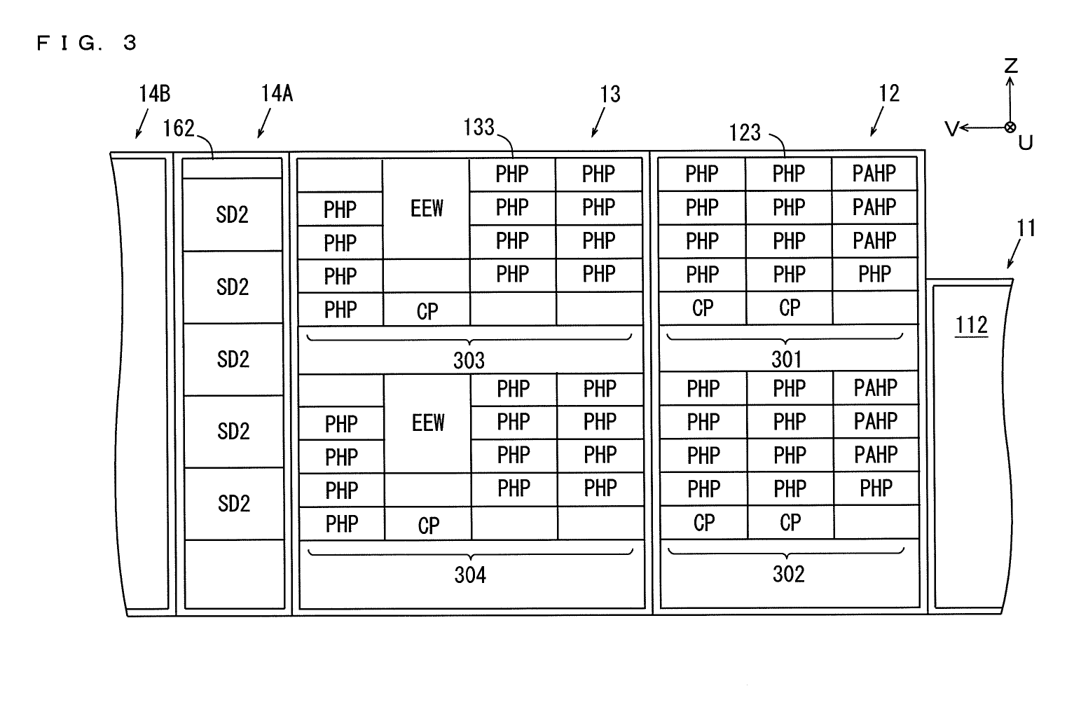

FIG. 3 is a schematic side view of the substrate processing apparatus 100 mainly showing the thermal processing sections 123, 133 and the cleaning drying processing section 162 of FIG. 1.

As shown in FIG. 3, the thermal processing section 123 has an upper thermal processing section 301 provided above, and a lower thermal processing section 302 provided below. In each of the upper thermal processing section 301 and the lower thermal processing section 302, a plurality of thermal processing units PHP, a plurality of adhesion reinforcement processing units PAHP and a plurality of cooling units CP are provided.

In each thermal processing unit PHP, heating processing and cooling processing for the substrate W are performed. Hereinafter, the heating processing and the cooling processing in the thermal processing unit PHP are simply referred to as thermal processing. Adhesion reinforcement processing for improving adhesion between the substrate W and the anti-reflection film is performed in the adhesion reinforcement processing unit PAHP. Specifically, in the adhesion reinforcement processing unit PAHP, an adhesion reinforcement agent such as HMDS (hexamethyldisilazane) is applied to the substrate W, and the heating processing is performed on the substrate W. In each cooling unit CP, the cooling processing for the substrate W is performed.

The thermal processing section 133 has an upper thermal processing section 303 provided above and a lower thermal processing section 304 provided below. A cooling unit CP, an edge exposure unit EEW and a plurality of thermal processing units PHP are provided in each of the upper thermal processing section 303 and the lower thermal processing section 304. In the edge exposure unit EEW, film thickness measurement processing for measuring a thickness of a film on the substrate W is performed, and the exposure processing for the peripheral portion of the substrate W (edge exposure processing) is performed. In the present embodiment, the edge exposure unit EEW has the alignment function for the substrate W. Details of the edge exposure unit EEW will be described below. In the upper thermal processing section 303 and the lower thermal processing section 304, each thermal processing unit PHP provided to be adjacent to the cleaning drying processing block 14A is configured to be capable of carrying in the substrate W from the cleaning drying processing block 14A.

A plurality (four in the present example) of cleaning drying processing units SD2 are provided in the cleaning drying processing section 162. In each cleaning drying processing unit SD2, the cleaning and drying processing for the substrate W after the exposure processing is performed.

### (4) Configuration of Transport Sections

FIG. 4 is a side view mainly showing the transport sections 122, 132, 163 of FIG. 1. As shown in FIG. 4, the transport section 122 has an upper transport chamber 125 and a lower transport chamber 126. The transport section 132 has an upper transport chamber 135 and a lower transport chamber 136. The transport mechanism 127 is provided in the upper transport chamber 125, and the transport mechanism 128 is provided in the lower transport chamber 126. Further, the transport mechanism 137 is provided in the upper transport chamber 135, and the transport mechanism 138 is provided in the lower transport chamber 136.

The substrate platform PASS3 and the substrate platform PASS1 are provided between the transport section 112 and the upper transport chamber 125, and the substrate platform PASS4 and the substrate platform PASS2 are provided between the transport section 112 and the lower transport chamber 126. The substrate platforms PASS5, PASS6 are provided between the upper transport chamber 125 and the upper transport chamber 135, and the substrate platforms PASS7, PASS8 are provided between the lower transport chamber 126 and the lower transport chamber 136.

The placement buffer unit P-BF1 is provided between the upper transport chamber 135 and the transport section 163, and the placement buffer unit P-BF2 is provided between the lower transport section 136 and the transport section 163. The substrate platform PASS9 and the plurality of placement cooling platforms P-CP are provided to be adjacent to the interface block 14 in the transport section 163. The substrate platform PASS9 has the alignment function for the substrate W. Each of the plurality of placement cooling platforms P-CP may have the alignment function for the substrate W.

The transport mechanism 127 is configured to be capable of transporting the substrate W among the substrate platforms PASS3, PASS1, PASS5, PASS6, the coating processing chambers 21, 22 (FIG. 2) and the upper thermal processing section 301 (FIG. 3). The transport mechanism 128 is configured to be capable of transporting the substrate W among the substrate platforms PASS4, PASS2, PASS7, PASS8, the coating processing chambers 23, 24 (FIG. 2) and the lower thermal processing section 302 (FIG. 3).

The transport mechanism 137 is configured to be capable of transporting the substrate W among the substrate platforms PASS5, PASSE, the placement buffer unit P-BF1, the development processing chambers 31, 32 (FIG. 2) and the upper thermal processing section 303 (FIG. 3). The transport mechanism 138 is configured to be capable of transporting the substrate W among the substrate platforms PASS7, PASS8, the placement buffer unit P-BF2, the development processing chambers 33, 34 (FIG. 2) and the lower thermal processing section 304 (FIG. 3).

Each of the transport mechanisms 127, 128, 137, 138, 141, 142, 146 has hands H1, H2 each transporting the substrate W while sucking the back surface of the substrate W and holding the substrate W. Thus, during transportation of the substrate W, the deviation of the position of the substrate W and a change in position of the notch NT with respect to the center of the substrate W on the hand H1, H2 is prevented.

### (5) Operation

The operation of the substrate processing apparatus 100 will be described with reference to FIGS. 1 to 4. The carrier 113 in which the unprocessed substrates W are stored is placed on the carrier platform 111 (FIG. 1) in the indexer block 11. The transport mechanism 115 transports the unprocessed substrate W from the carrier 113 to the substrate platform PASS3, PASS4 (FIG. 4). At this time, in the substrate platform PASS3, PASS4, the alignment for the substrate W is performed. Further, the transport mechanism 115 transports the processed substrate W that is placed on the substrate platform PASS1, PASS2 (FIG. 4) to the carrier 113.

In the first processing block 12, the transport mechanism 127 (FIG. 4) sequentially transports the substrate W aligned by the substrate platform PASS3 (FIG. 4) to the adhesion reinforcement processing unit PAHP (FIG. 3), the cooling unit CP (FIG. 3), the coating processing chamber 22 (FIG. 2), the thermal processing unit PHP (FIG. 3), the cooling unit CP (FIG. 3), the coating processing chamber 21 (FIG. 2), the thermal processing unit PHP (FIG. 3) and the substrate platform PASS5 (FIG. 4).

In this case, after the adhesion reinforcement processing is performed on the substrate W in the adhesion reinforcement processing unit PAHP, the substrate W is cooled to a temperature suitable for formation of the anti-reflection film in the cooling unit CP. Next, the anti-reflection film is formed on the substrate W by the coating processing unit 129 (FIG. 2) in the coating processing chamber 22 after the alignment for the substrate W is performed. Subsequently, after the thermal processing for the substrate W is performed in the thermal processing unit PHP, the substrate W is cooled to a temperature suitable for the formation of the resist film in the cooling unit CP. Next, in the coating processing chamber 21, the resist film is formed on the substrate W by the coating processing unit 129 (FIG. 2) after the alignment for the substrate W is performed, and edge rinse processing is performed. Thereafter, the thermal processing for the substrate W is performed in the thermal processing unit PHP, and the substrate W is placed on the substrate platform PASS5.

Further, the transport mechanism 127 transports the substrate W after the development processing that is placed on the substrate platform PASS6 (FIG. 4) to the substrate platform PASS1 (FIG. 4).

The transport mechanism 128 (FIG. 4) sequentially transports the substrate W aligned by the substrate platform PASS4 (FIG. 4) to the adhesion reinforcement processing unit PAHP (FIG. 3), the cooling unit CP (FIG. 3), the coating processing chamber 24 (FIG. 2), the thermal processing unit PHP (FIG. 3), the cooling unit CP (FIG. 3), the coating processing chamber 23 (FIG. 2), the thermal processing unit PHP (FIG. 3) and the substrate platform PASS7 (FIG. 4). Further, the transport mechanism 128 (FIG. 4) transports the substrate W after the development processing that is placed on the substrate platform PASS8 (FIG. 4) to the substrate platform PASS2 (FIG. 4). The processing contents for the substrate W in the coating processing chambers 23, 24 (FIG. 2) and the lower thermal processing section 302 (FIG. 3) are similar to the processing contents for the substrate W in the above-mentioned coating processing chambers 21, 22 (FIG. 2) and the upper thermal processing section 301 (FIG. 3).

In the second processing block 13, the transport mechanism 137 (FIG. 4) sequentially transports the substrate W after the resist film formation that is placed on the substrate platform PASS5 (FIG. 4) to the edge exposure unit EEW (FIG. 3) and the placement buffer unit P-BF1 (FIG. 4). In this case, in the edge exposure unit EWW, the film thickness measurement and the edge exposure processing are performed after the alignment for the substrate W is performed.

Further, the transport mechanism 137 (FIG. 4) takes out the substrate W after the exposure processing and the thermal processing from the thermal processing unit PHP (FIG. 3) that is adjacent to the cleaning drying processing block 14A, and sequentially transports the substrate W to the cooling unit CP (FIG. 3), any one of the development processing chambers 31, 32 (FIG. 2), the thermal processing unit PHP (FIG. 3) and the substrate platform PASS6 (FIG. 4).

In this case, in the cooling unit CP, the development processing for the substrate W is performed by the development processing unit 139 in any one of the development processing chambers 31, 32 after the substrate W is cooled to a temperature suitable for the development processing. Thereafter, in the thermal processing unit PHP, the thermal processing for the substrate W is performed, and the substrate W is placed on the substrate platform PASS6.

The transport mechanism 138 (FIG. 4) sequentially transports the substrate W after the resist film formation that is placed on the substrate platform PASS7 (FIG. 4) to the edge exposure unit EEW (FIG. 3) and the placement buffer unit P-BF2 (FIG. 4). Further, the transport mechanism 138 (FIG. 4) takes out the substrate W after the exposure processing and the thermal processing from the thermal processing unit PHP (FIG. 3) that is adjacent to the cleaning drying processing block 14A, and sequentially transports the substrate W to the cooling unit CP (FIG. 3), any one of the development processing chambers 33, 34 (FIG. 2), the thermal processing unit PHP (FIG. 3) and the substrate platform PASS8 (FIG. 4). The processing contents for the substrate W in the development processing chambers 33, 34 and the lower thermal processing section 304 are similar to the processing contents for the substrate W in the above-mentioned development processing chambers 31, 32 and the upper thermal processing section 303.

In the cleaning drying processing block 14A, the transport mechanism 141 (FIG. 1) sequentially transports the substrate W that is placed on the placement buffer unit P-BF1, P-BF2 (FIG. 4) to the cleaning drying processing unit SD1 (FIG. 2) in the cleaning drying processing section 161 and the placement cooling platform P-CP (FIG. 4). In this case, the substrate W is cooled in the placement cooling platform P-CP to a temperature suitable for the exposure processing in the exposure device 15 (FIGS. 1 to 3) after the alignment for the substrate W and the cleaning and drying processing for the substrate W are performed in the cleaning drying processing unit SD1.

The transport mechanism 142 (FIG. 1) transports the substrate W after the exposure processing that is placed on the substrate platform PASS9 (FIG. 4) to the cleaning drying processing unit SD2 (FIG. 3) in the cleaning drying processing section 162, and transports the substrate W after the cleaning and drying processing to the thermal processing unit PHP (FIG. 3) in the upper thermal processing section 303 or the thermal processing unit PHP (FIG. 3) in the lower thermal processing section 304 from the cleaning drying processing unit SD2. In this case, the alignment for the substrate W is performed in the substrate platform PASS9. In the thermal processing unit PHP, post-exposure bake (PEB) processing is performed.

In the interface block 14, the transport mechanism 146 (FIG. 1) transports the substrate W before the exposure processing that is placed on the placement cooling platform P-CP (FIG. 4) to the substrate inlet 15a (FIG. 1) of the exposure device 15. Further, the transport mechanism 146 (FIG. 1) takes out the substrate W after the exposure processing from the substrate outlet 15b (FIG. 1) of the exposure device 15, and transports the substrate W to the substrate platform PASS9 (FIG. 4).

When an exposure transport section 200 cannot receive the substrate W, the substrate W before the exposure processing is temporarily stored in the placement buffer unit P-BF1, P-BF2. Further, when the development processing unit 139 (FIG. 2) in the second processing block 13 cannot receive the substrate W after the exposure processing, the substrate W after the exposure processing is temporarily stored in the placement buffer unit P-BF1, P-BF2. In the placement buffer unit P-BF1, P-BF2, the alignment for the substrate W may be performed.

In the present embodiment, processing for the substrate W in the coating processing chambers 21, 22, the development processing chambers 31, 32 and the upper thermal processing sections 301, 303 that are provided above, and the processing for the substrate W in the coating processing chambers 23, 24, the development processing chambers 33, 34 and the lower thermal processing sections 302, 304 that are provided below can be concurrently performed. Thus, it is possible to improve throughput without increasing a footprint.

### (6) Configuration and Operation of Edge Exposure Units EEW

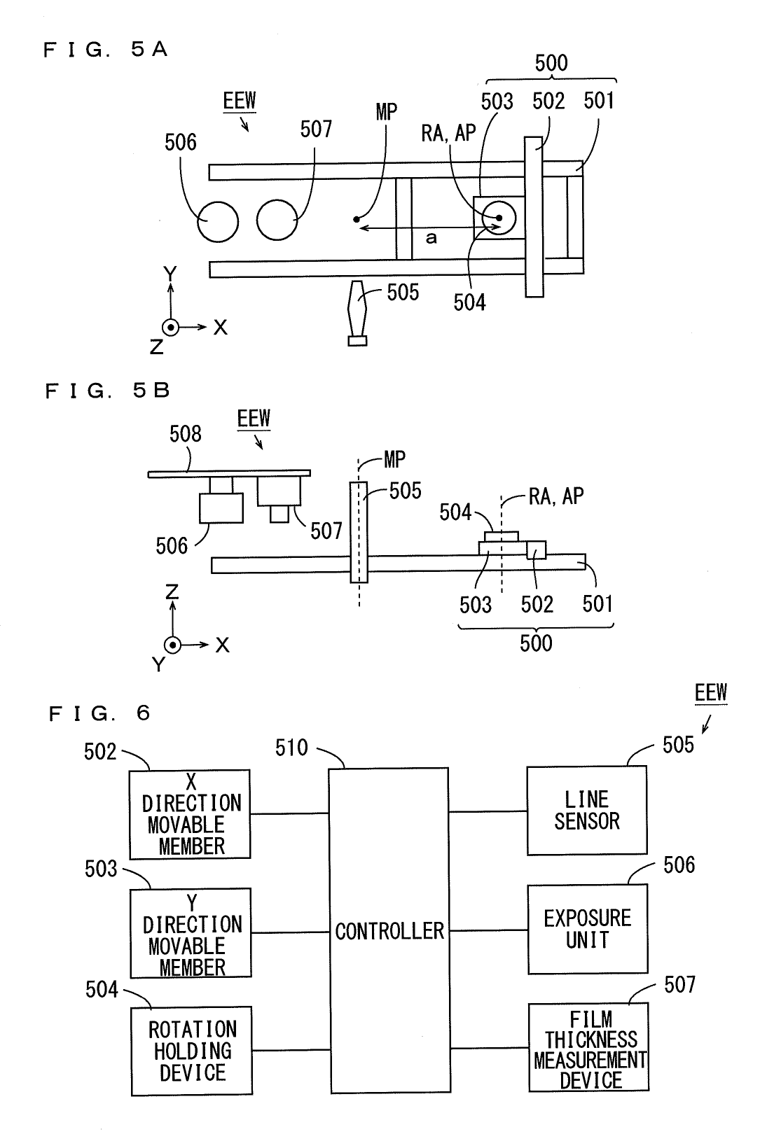

FIGS. 5A, 5B are a schematic plan view and a schematic side view showing a configuration of each edge exposure unit EEW. In FIG. 5A and subsequent given diagrams, two directions that are orthogonal to each other within a horizontal plane are defined as an X direction and a Y direction, and a vertical direction is defined as a Z direction. In the present embodiment, the Y direction is a reference direction. In the following description, the X direction means a direction of an arrow X or a direction opposite to the direction of the arrow X, and the Y direction means a direction of an arrow Y or a direction opposite to the direction of the arrow Y.

As shown in FIGS. 5A, 5B, the edge exposure unit EEW includes a moving device 500, a rotation holding device 504, a line sensor 505, an exposure unit 506 and a film thickness measurement device 507. The moving device 500 includes a support member 501, an X direction movable portion 502 and a Y direction movable portion 503.

The X direction movable portion 502 is configured to be movable in the X direction with respect to the support member 501. The Y direction movable portion 503 is configured to be movable in the Y direction with respect to the X direction movable portion 502. The rotation holding device 504 is fixed to the X direction movable portion 502. For example, the rotation holding device 504 is made of a suction-type spin chuck, and sucks the back surface of the substrate W and holds the substrate W in a horizontal attitude. This rotation holding device 504 is driven to be rotated about a rotation axis RA in the vertical direction by a motor (not shown) provided at the Y direction movable portion 503. Thus, the substrate W is rotated about the rotation axis RA.

A CCD (Charge-Coupled Device) line sensor is used as the line sensor 505, for example. The line sensor 505 is arranged to extend in the Y direction. The line sensor 505 is used to measure a position of an outer periphery of the substrate W in the Y direction.

The exposure unit 506 is used to expose the peripheral portion of the film such as the resist film or the like that is formed on the substrate W. The film thickness measurement device 507 is used to measure the thickness of the film on the substrate W. The exposure unit 506 and the film thickness measurement device 507 are fixed to a fixing member 508.

An assumption position AP for performing transfer of the substrate W between the hand H1, H2 (see FIGS. 1 and 4) and the rotation holding device 504 is set. A measurement position MP is set between the assumption position AP and the film thickness measurement device 507. The line sensor 505 is provided to extend on a straight line passing through the measurement position MP. The measurement position MP and the assumption position AP are arranged on a straight line in the X direction. The distance between the assumption position AP and the measurement position MP is “a”.

In an initial state, the X direction movable portion 502 and the Y direction movable portion 503 are positioned such that the rotation axis RA of the rotation holding device 504 coincides with the assumption position AP.

FIG. 6 is a block diagram showing a configuration of a control system of the edge exposure unit EEW. As shown in FIG. 6, the edge exposure unit EEW further includes a controller 510. The controller 510 is constituted by a CPU (Central Processing Unit), a memory and the like. The controller 510 controls the X direction movable portion 502, the Y direction movable portion 503 of the moving device 500 and the rotation holding device 504 based on output signals of the line sensor 505. Further, the controller 510 controls operations of the exposure unit 506 and the film thickness measurement device 507 and acquires a result of measurement of the film thickness measurement device 507.

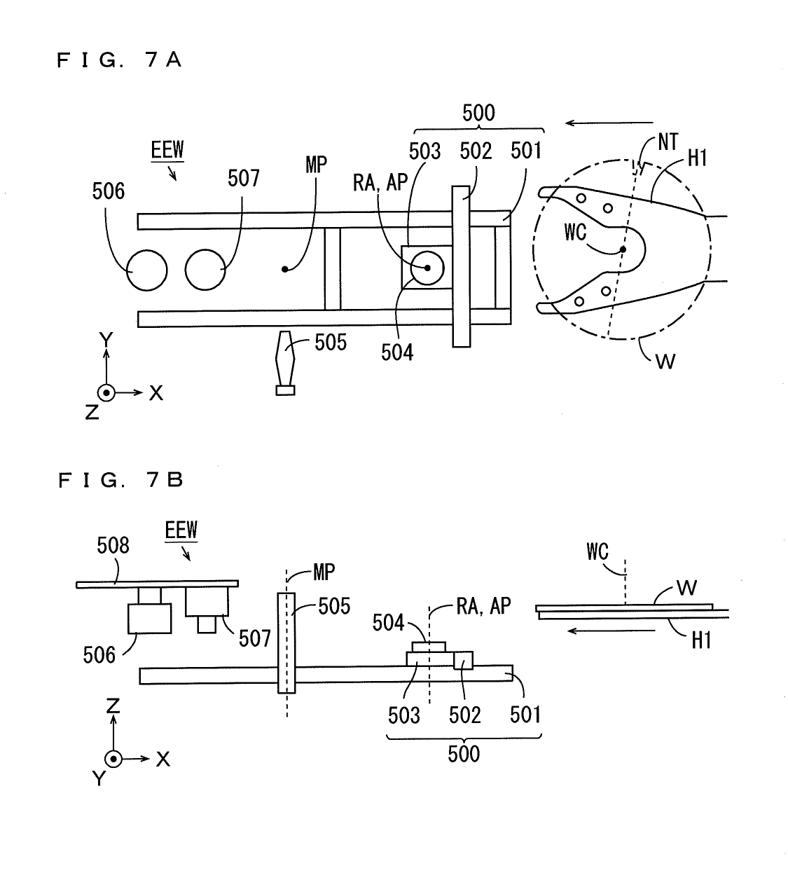

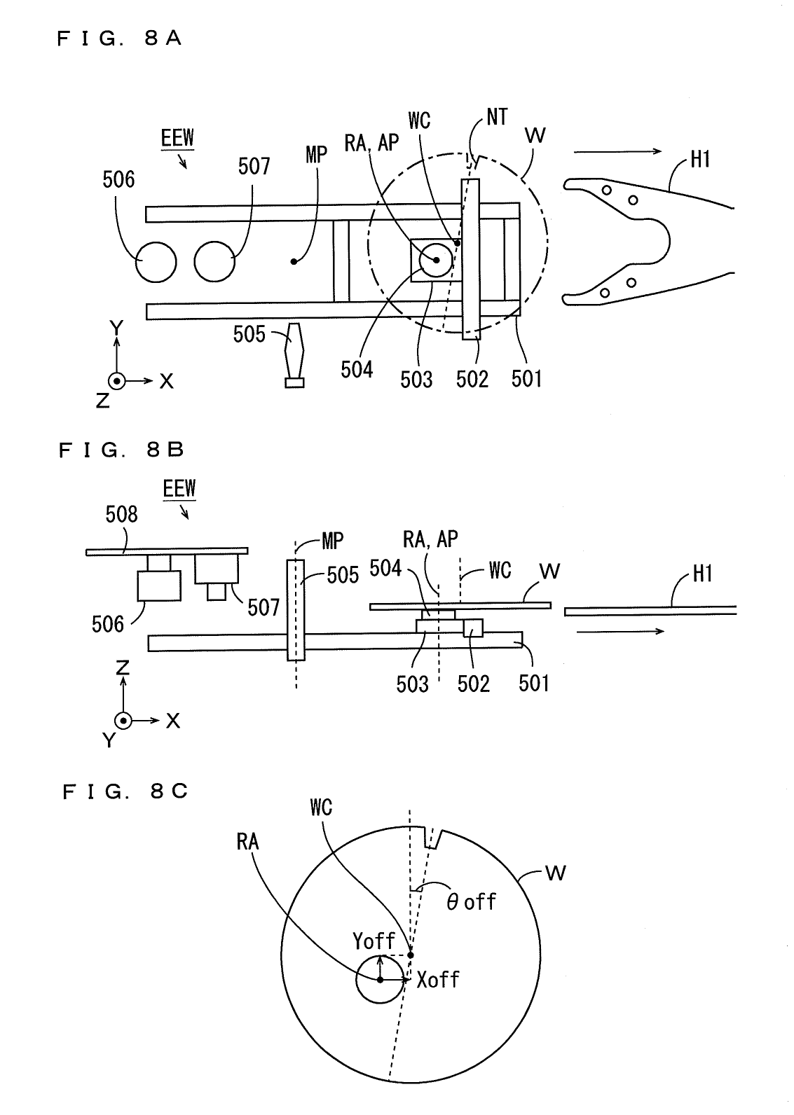

FIG. 7A to FIG. 12B are schematic diagrams for explaining operations of the edge exposure unit EEW of FIGS. 5A, 5B. FIGS. 7A, 8A, 9A, 10A, 11A, 12A are schematic plan views, and FIGS. 7B, 8B, 9B, 10B, 11B, 12B are schematic side views. FIG. 8C is an enlarged plan view of the substrate W.

First, as shown in FIGS. 7A, 7B, the substrate W is carried into the edge exposure unit EEW by the hand H1 of the transport mechanism 137 (FIG. 4) or the transport mechanism 138 (FIG. 4). In this case, as indicated by arrows, the hand H1 holding the substrate W enters the edge exposure unit EEW. The substrate W may be carried into the edge exposure unit EEW by the hand H2. The substrate W has a notch NT at a portion of the outer periphery.

Next, as shown in FIGS. 8A, 8B, the hand H1 places the substrate W on an upper surface of the rotation holding device 504 and exits from the edge exposure unit EEW as indicated by arrows. As shown in FIG. 8C, a direction of a straight line connecting the center WC and the notch NT of the substrate W is referred to as a direction of the notch NT. Further, an angle, which the direction of the notch NT forms with the reference direction (the Y direction), is referred to as a rotation direction offset amount θoff. In the examples of FIGS. 8A to 8C, the direction of the notch NT does not coincide with the reference direction. Further, an amount of deviation from the rotation axis RA to the center WC of the substrate W in the X direction is referred to as an X offset amount Xoff, and an amount of deviation from the rotation axis RA to the center WC of the substrate W in the Y direction is referred to as a Y offset amount Yoff. In the example of FIGS. 8A to 8C, the center WC of the substrate W does not coincide with the rotation axis RA of the rotation holding device 504. That is, the center WC of the substrate W deviates from the rotation axis RA.

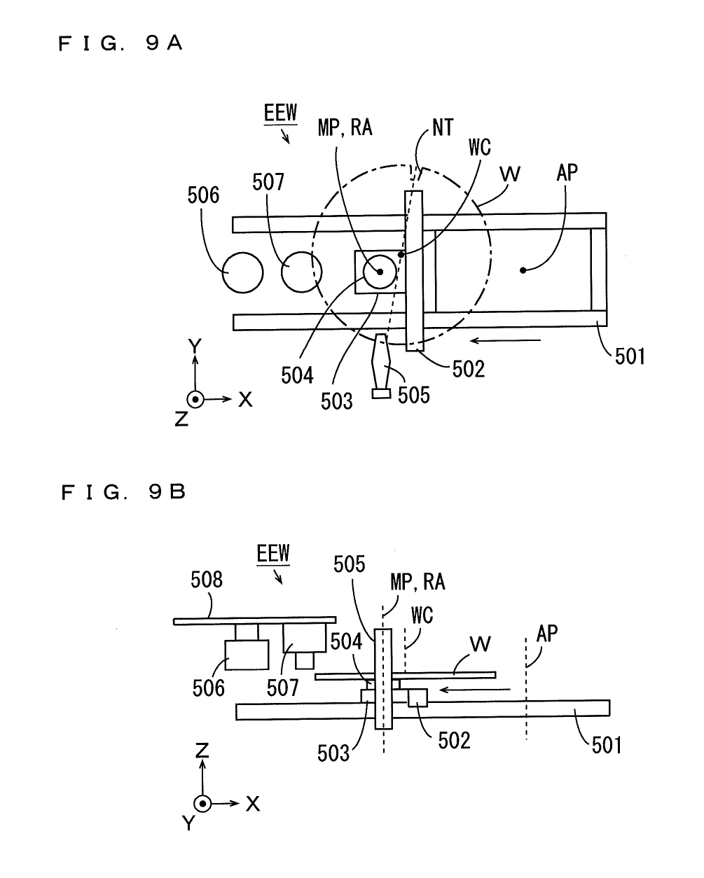

Next, as indicated by arrows in FIGS. 9A, 9B, the X direction movable portion 502 is moved together with the Y direction movable portion 503 and the rotation holding device 504 by the distance “a” in the X direction towards the measurement position MP. Thus, the rotation axis RA of the rotation holding device 504 coincides with the measurement position MP.

In this state, as indicated by an arrow in FIG. 10A, the rotation holding device 504 is rotated by 360° about the rotation axis RA. When the rotation holding device 504 is rotated by 360°, the substrate W returns to the state of FIGS. 9A, 9B. During the rotation of the substrate W, the controller 510 of FIG. 6 acquires the output signals of the line sensor 505 as position data. The position data indicates the positions of the outer periphery of the substrate W in the Y direction.

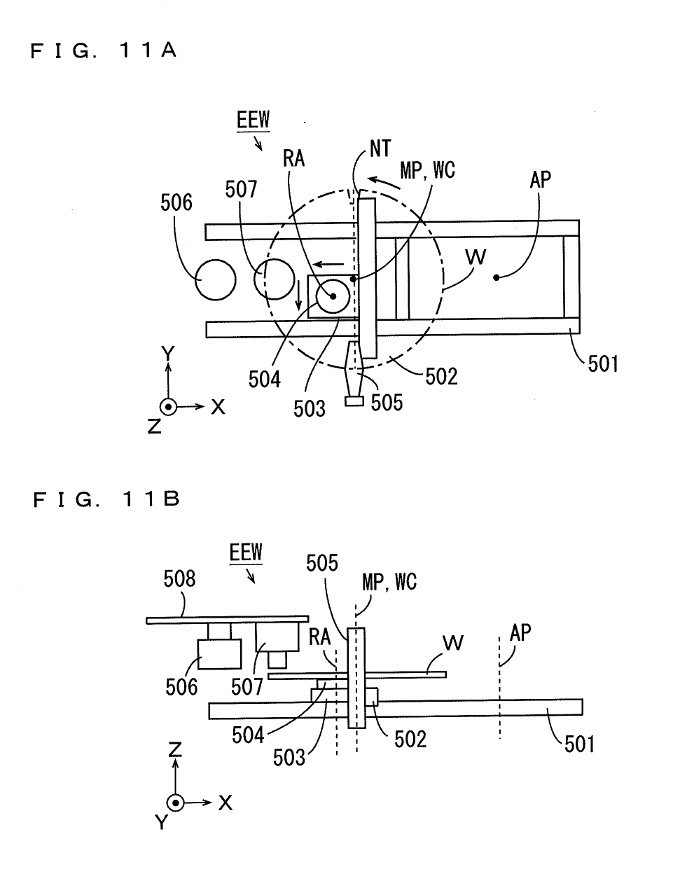

A calculation method of the direction of the center WC and the notch NT of the substrate W will be described with reference to FIG. 13. FIG. 13 is a diagram showing one example of the position data acquired based on the output signals of the line sensor 505. The ordinate in FIG. 13 indicates the position data, and the abscissa in FIG. 13 indicates a rotation angle of the substrate W.

When the center WC of the substrate W deviates from the rotation axis RA, values of the position data change in accordance with the rotation of the substrate W as shown in FIG. 13. The controller 510 acquires the position data for every rotation of the substrate W by 0.1 degree, for example. In this case, total 3600 of the position data are acquired. The controller 510 detects the position data Pn corresponding to the notch NT based on a change in position data and calculates the rotation direction offset amount θoff of the notch NT based on the rotation angle corresponding to the position data Pn.

Further, the controller 510 calculates the X offset amount Xoff and the Y offset amount Yoff of the center WC of the substrate W with respect to the rotation axis RA based on a change in position data.

Letting the position data when the rotation angles of the substrate W are 0°, 90°, 180° and 270° be PA0, PA1, PA2 and PA3, respectively. In this case, the X offset amount Xoff and the Y offset amount Yoff are calculated in the following formula.

Xoff=(PA1−PA3)/2 (1)

Yoff=(PA0−PA2)/2 (2)

Further, letting the position data when the rotation angles of the substrate W are 45°, 135°, 225° and 315° be PB0, PB1, PB2 and PB3, respectively. In this case, the X offset amount Xoff and the Y offset amount Yoff are calculated in the following formula.

Xoff=(PB1−PB3)/2×cos 45°−(PB0−PB2)/2×sin 45° (3)

Yoff=(PB1−PB3)/2×sin 45°−(PB0−PB2)/2×cos 45° (4)

When the notch NT is at any one of the rotation angles 45°, 135°, 225° and 315° or a position in the vicinity of them, the X offset amount Xoff and the Y offset amount Yoff are calculated using the above formulas (1), (2). Further, when the notch NT is at any one of the rotation angles 0°, 90°, 180°, 270° or a position in the vicinity of them, the X offset amount Xoff and the Y offset amount Yoff are calculated using the above formulas (3), (4).

Next, the X direction movable portion 502 and the Y direction movable portion 503 are moved such that the X offset amount and the Y offset amount become 0. Thus, the center WC of the substrate W coincides with the measurement position MP. At this time, the rotation holding device 504 may be rotated such that the rotation direction offset amount θoff becomes 0. In this state, the rotation holding device 504 is rotated by 360° about the rotation axis RA, and the controller 510 calculates the rotation direction offset amount θoff, the X offset amount Xoff and the Y offset amount Yoff.

Next, as shown in FIGS. 11A, 11B, the X direction movable portion 502 and the Y direction movable portion 503 are moved such that the X offset amount and the Y offset amount becomes 0, and the rotation holding device 504 is rotated such that the rotation direction offset amount θoff becomes 0. Thus, the center WC of the substrate W coincides with the measurement position MP, and the direction of the notch NT coincides with the reference direction.

In the present embodiment, the center WC of the substrate W coincides with the measurement position MP, and the direction of the notch NT coincides with the reference direction by an alignment operation for the substrate W. The alignment operation for the substrate W may be repeated a number of times. Thus, the center WC of the substrate W can accurately coincide with the measurement position MP, and the direction of the notch NT can accurately coincide with the reference direction.

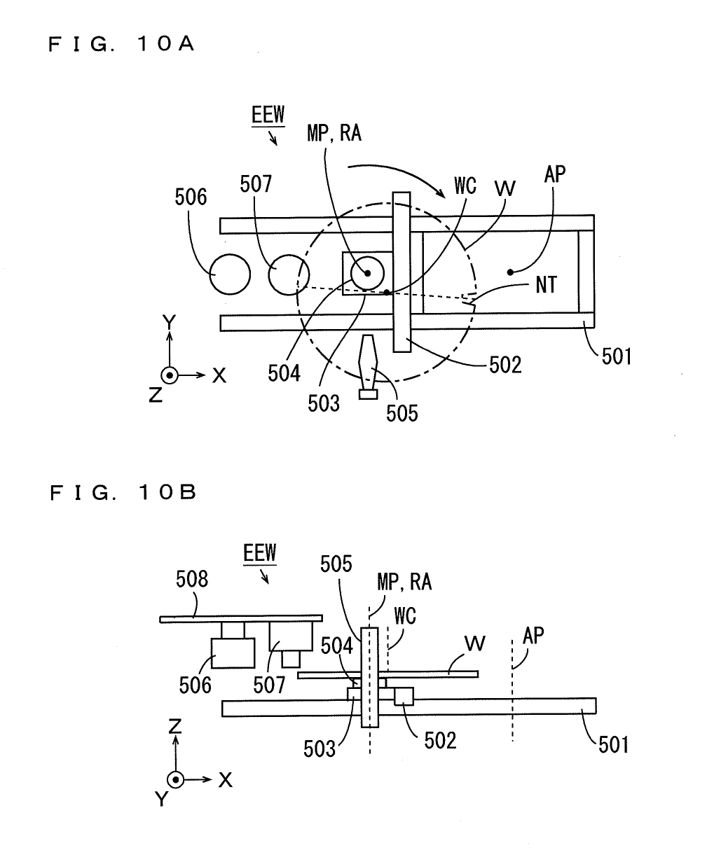

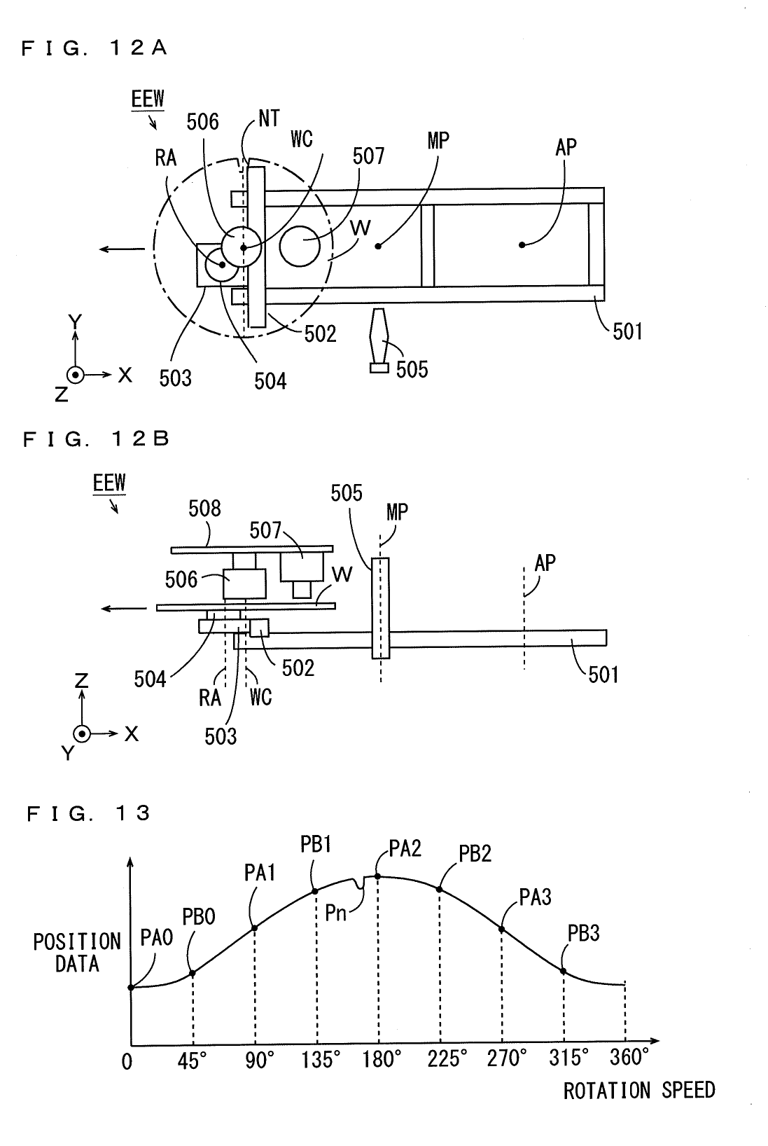

Thereafter, as shown in FIGS. 12A, 12B, the film thickness measurement device 507 sequentially measures the thickness of the film on the substrate W while the X direction movable portion 502 is moved in the X direction. FIGS. 14A, 14B are schematic plan views showing one example of a film thickness measurement method by the film thickness measurement device 507.

As shown in FIG. 14A, during the movement of the X direction movable portion 502 that is shown in FIGS. 12A, 12B, the thicknesses of the film at a plurality of measurement points mp on a straight line orthogonal to the straight line passing through the center WC and the notch NT of the substrate W are sequentially measured. Next, after the rotation holding device 504 is rotated by 90°, the film thickness measurement device 507 sequentially measures the thicknesses of the film on the substrate W while the X direction movable portion 502 is moved in the X direction. Thus, as shown in FIG. 14B, the film thicknesses at the plurality of measurement points mp on the straight line passing through the center WC and the notch NT of the substrate W are measured.

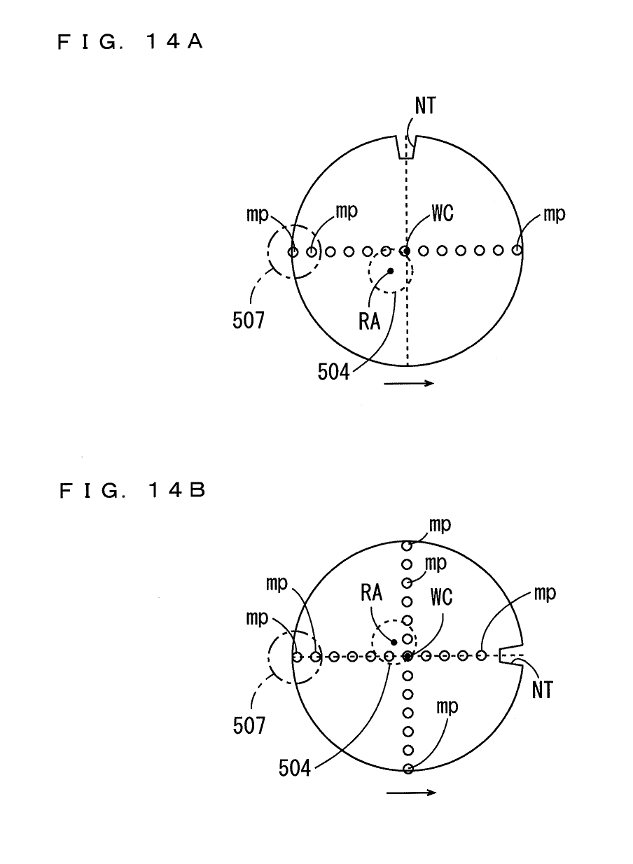

FIGS. 15A, 15B are schematic plan views showing another example of the film thickness measurement method by the film thickness measurement device 507.

The rotation holding device 504 is rotated about the rotation axis RA, and the film thickness measurement device 507 successively measures the thicknesses of the film on the substrate W. At this time, the X direction movable portion 502 and the Y direction movable portion 503 move the rotation holding device 504 in the X and Y directions for every rotation of the rotation holding device 504 by a constant angle such that the center WC of the substrate W is not moved. In this case, as shown in FIG. 15A, an operation of moving the rotation holding device 504 in the X and Y directions by the X direction movable portion 502 and the Y direction movable portion 503 such that the center WC of the substrate W is not moved is referred to as an XY correction operation.

In FIG. 15A, a trajectory of the rotation holding device 504 is drawn by solid lines. Thus, the thickness of the film in a measurement region mr in a circular arc shape on the substrate W is measured. The substrate W is rotated by 360°, so that the thickness of the film in the measurement region mr in the circular arc shape is measured as shown in FIG. 15B.

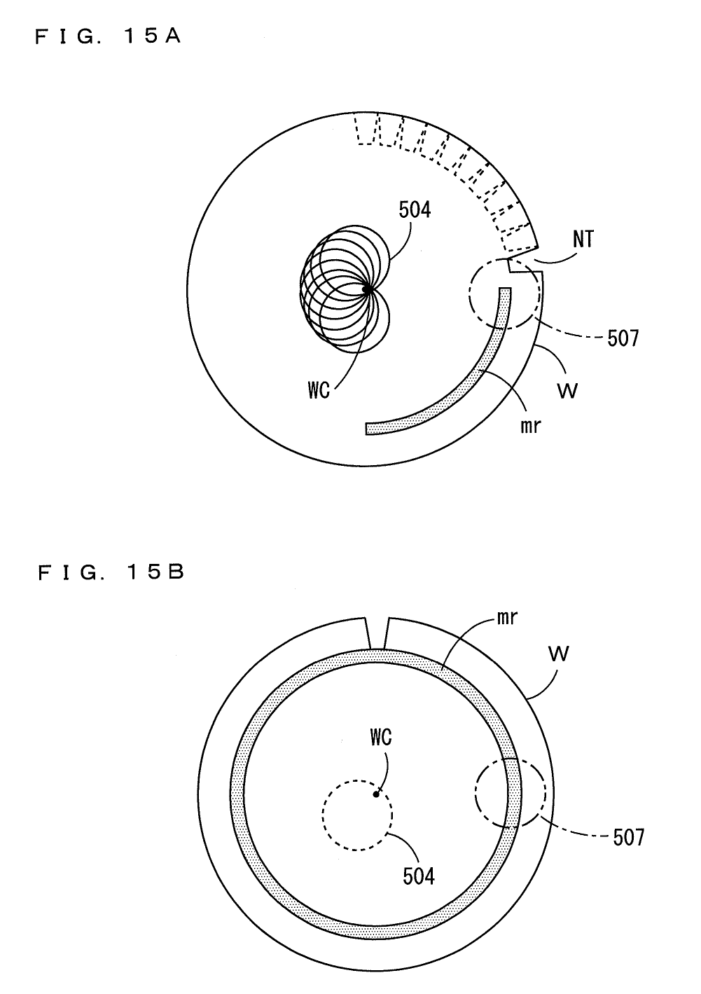

FIGS. 16A, 16B are schematic plan views showing an edge exposure method for the substrate W by the exposure unit 506.

The X direction movable portion 502 is moved in the X direction such that the exposure unit 506 of FIGS. 12A, 12B is positioned above the peripheral portion of the upper surface of the substrate W. At this time, the center WC of the substrate W coincides with a predetermined reference axis RR. Thereafter, the rotation holding device 504 is rotated about the rotation axis RA, and the peripheral portion of the upper surface of the substrate W is irradiated with light for exposure by the exposure unit 506. At this time, the X direction movable portion 502 and the Y direction movable portion 503 move the rotation holding device 504 in the X and Y directions for every rotation of the rotation holding device 504 by a constant angle such that the center WC of the substrate W is not moved. In this case, the rotation holding device 504 is moved by the XY correction operation as shown in FIG. 16A. In this case, the substrate W is rotated with the center WC of the substrate W coinciding with the reference axis RR. Thus, a region mra in a circular arc shape at the peripheral portion of the film on the substrate W is irradiated with the light. The substrate W is rotated by 360°, so that the annular region mra at the peripheral portion of the film on the substrate W is irradiated with the light as shown in FIG. 16B.

In the edge exposure unit EEW according to the present embodiment, the film thickness is measured after the alignment operation is performed such that the center WC of the substrate W coincides with the preset predetermined measurement position MP and the direction of the notch NT coincides with the reference direction. Thus, the thickness at a predetermined position of the film on the substrate W can be accurately measured.

Further, because the substrate W is rotated with the center WC of the substrate W coinciding with the reference axis RR during the edge exposure processing, a region, having a constant width, at the peripheral portion of the film on the substrate W can be accurately exposed.

Further, because the center WC of the substrate W coincides with the measurement position MP by the alignment operation of FIGS. 11A, 11B, the line sensor 505 extends in a radial direction of the substrate W. In this state, when the direction of the notch NT is detected again, the outer periphery of the substrate W passes through substantially the same portion of the line sensor 505 during the rotation of the substrate W. Thus, influence of a measurement error, which is depended on a position of a light receiving surface of the line sensor 505, can be reduced. Further, the line sensor 505 orthogonally intersects with the outer periphery of the substrate W during the rotation of the substrate W. As a result, the direction of the notch NT can be accurately detected.

### (7) First Example of Coating Processing Units 129

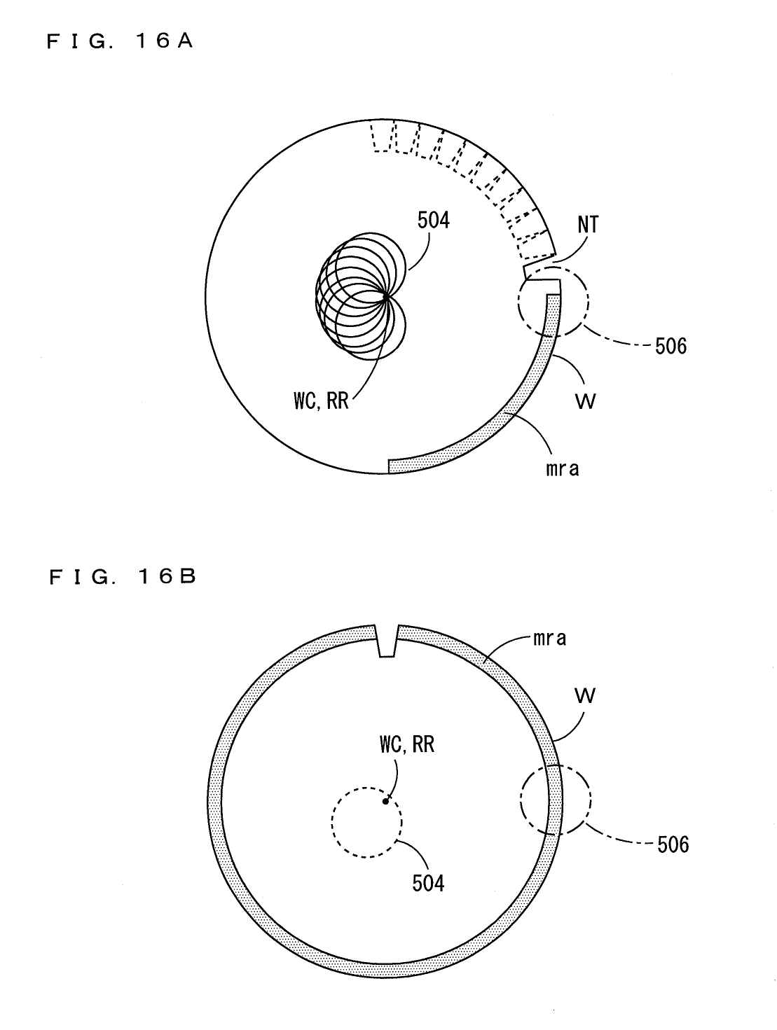

FIGS. 17A, 17B are a schematic plan view and a schematic side view showing a configuration of the first example of each coating processing unit 129.

As shown in FIGS. 17A, 17B, the coating processing unit 129 includes the moving device 500, the rotation holding device 504, the line sensor 505, the spin chuck 25, the processing liquid nozzle 28 and an edge rinse nozzle 520. The moving device 500 has the similar configuration to the moving device 500 of FIGS. 5A, 5B except that the moving device 500 includes a Y direction movable portion 503a instead of the Y direction movable portion 503 of FIGS. 5A, 5B. The Y direction movable portion 503a is configured to be movable in the Y direction and also movable in the Z direction with respect to the X direction movable portion 502.

The spin chuck 25 sucks the back surface of the substrate W and holds the substrate W in the horizontal attitude and is driven to be rotated about a rotation axis Ra in the vertical direction. This spin chuck 25 is configured to be rotatable at a higher speed than the rotation holding device 504.

The processing liquid nozzle 28 is used to supply the processing liquid such as the resist liquid to the upper surface of the substrate W. The edge rinse nozzle 520 is used to supply the rinse liquid to the peripheral portion of the film on the substrate W. While only one spin chuck 25 is shown in FIGS. 17A, 17B, the plurality of moving devices 500 and the plurality of line sensors 505 are provided to correspond to the plurality of spin chucks 25 of FIG. 2. In FIGS. 17A, 17B, the cup 27 is not shown.

The assumption position AP is set on the opposite side to the rotation axis Ra of the spin chuck 25 with respect to the measurement position MP. The rotation axis Ra, the measurement position MP and the assumption position AP are arranged on a straight line in the X direction. The distance between the assumption position AP and the measurement position MP is “a”, and the distance between the measurement position MP and the rotation axis Ra is “b”. In the initial state, the rotation axis RA of the rotation holding device 504 is at a position that deviates from the assumption position AP.

FIG. 18 is a block diagram showing a configuration of a control system of the coating processing unit 129. As shown in FIG. 18, the coating processing unit 129 further includes a controller 510a, a processing liquid supply system 28a and a rinse liquid supply system 520a. The processing liquid supply system 28a and the rinse liquid supply system 520a are provided in the fluid box 50 (FIG. 2). The processing liquid supply system 28a supplies the processing liquid such as the resist liquid to the processing liquid nozzle 28. The rinse liquid supply system 520a supplies the rinse liquid that dissolves the film such as the resist film to the edge rinse nozzle 520. The controller 510a controls the X direction movable portion 502 and the Y direction movable portion 503a of the moving device 500 and the rotation holding device 504 based on the output signals of the line sensor 505. Further, the controller 510a controls the spin chuck 25, a processing liquid supply system 25a and the rinse liquid supply system 520a.

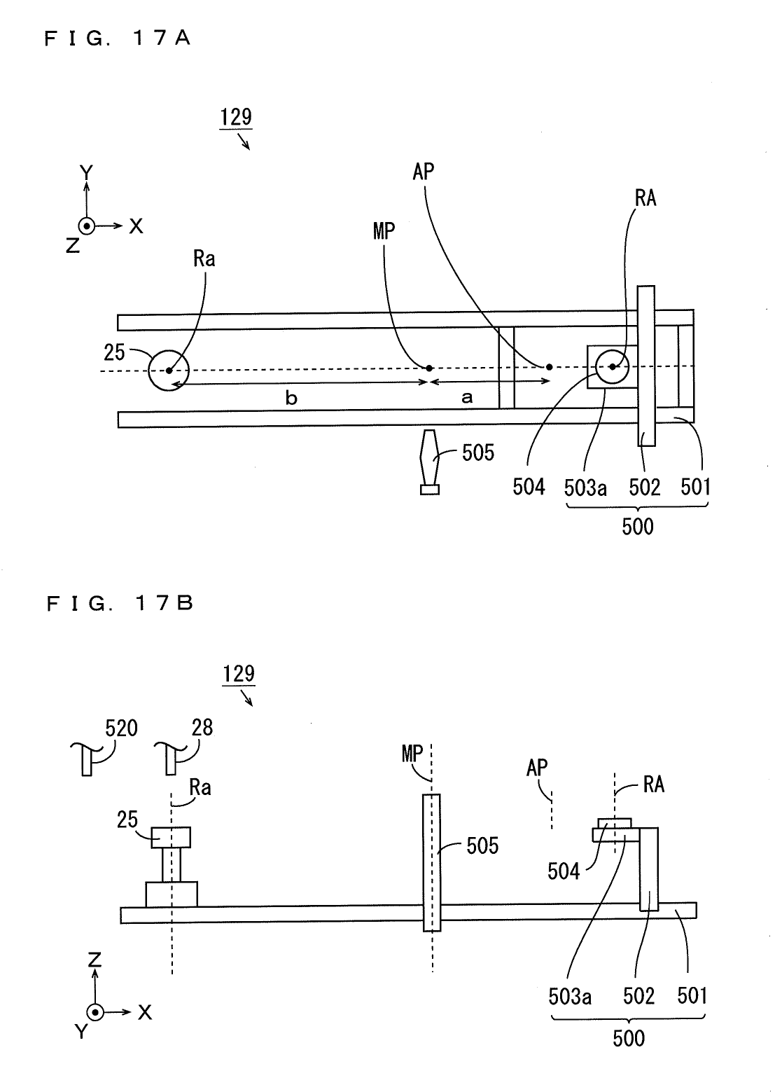

FIGS. 19A, 19B to FIGS. 22A, 22B are schematic plan views and schematic side views for explaining operations of the coating processing unit 129 of FIGS. 17A, 17B.

First, as shown in FIGS. 19A, 19B, the hand H1 or the hand H2 of the transport mechanism 127 or the transport mechanism 128 of FIG. 4 places the substrate Won the upper surface of the rotation holding device 504. In this case, the substrate W is placed such that the center WC deviates from the rotation axis RA of the rotation holding device 504. Thus, a portion that is close to the outer periphery of the substrate W is held by the rotation holding device 504. Ideally, it is desirable that the substrate W is placed on the upper surface of the rotation holding device 504 such that the direction of the notch NT coincides with the reference direction and the center WC coincides with the assumption position AP. However, in the example of FIGS. 19A, 19B, the direction of the notch NT does not coincide with the reference direction, and the center WC of the substrate W does not coincide with the assumption position AP.

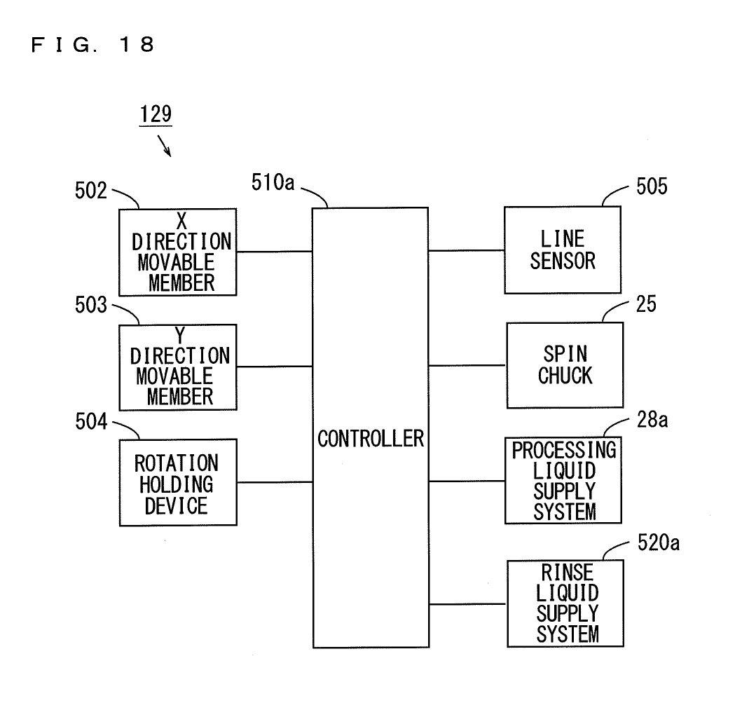

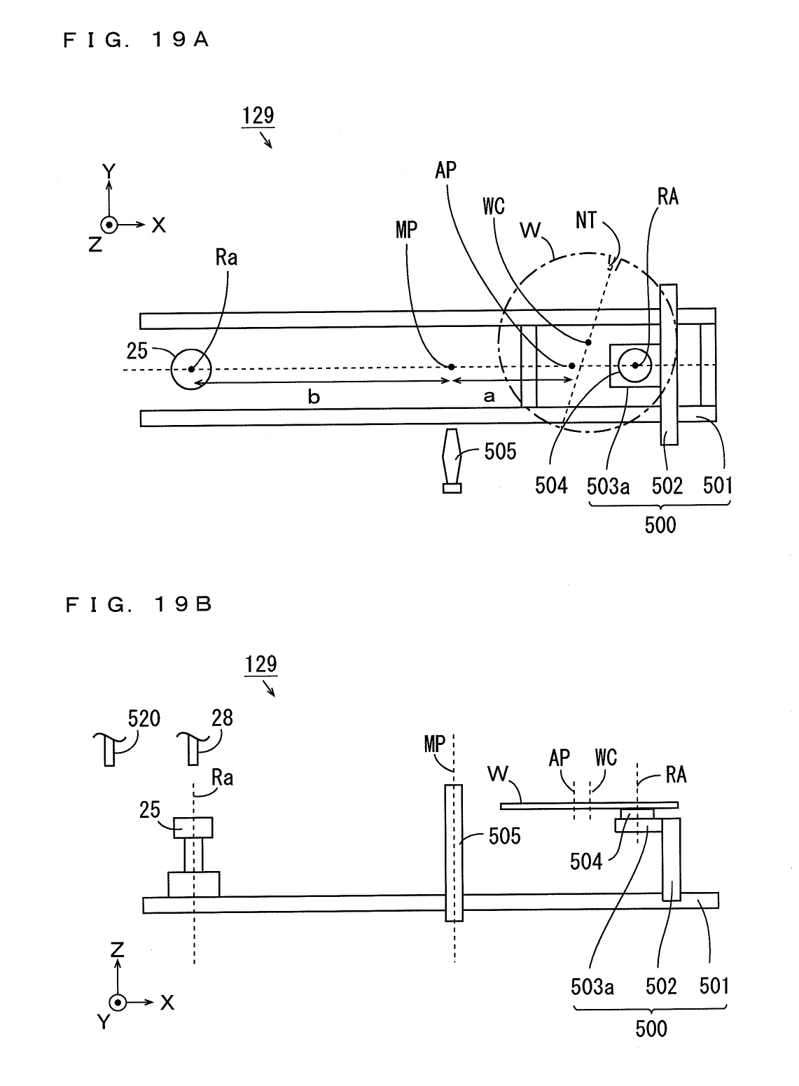

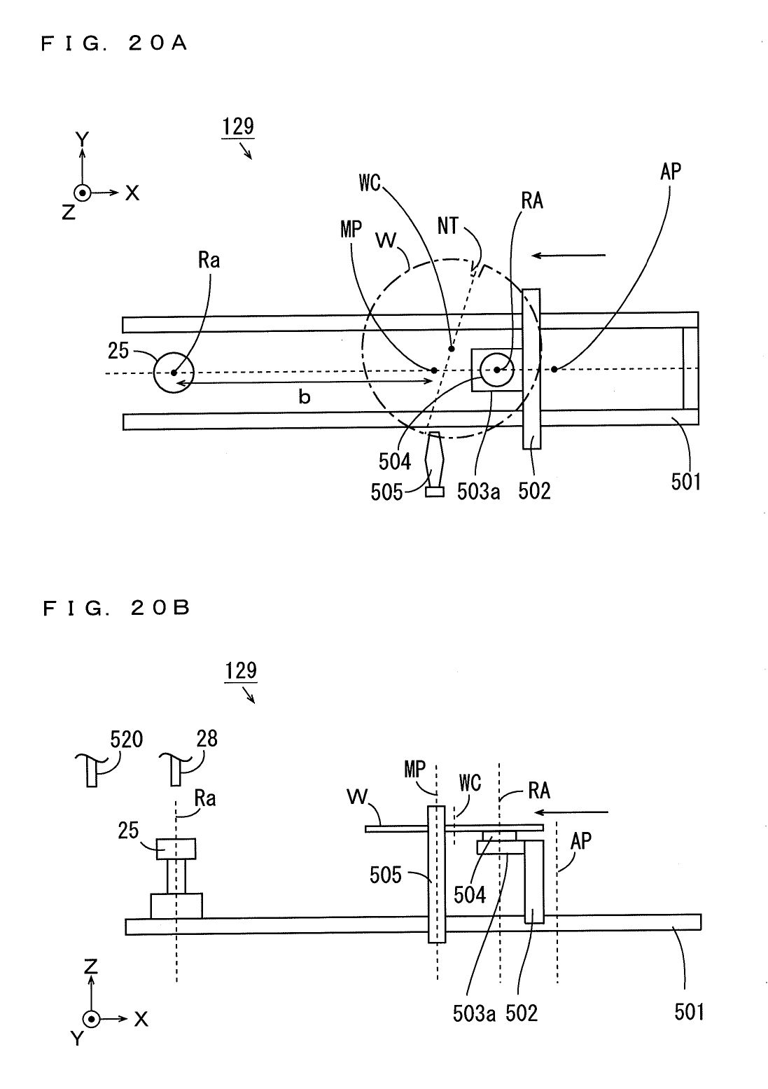

Next, as indicated by arrows in FIGS. 20A, 20B, the X direction movable portion 502 is moved together with the Y direction movable portion 503a and the rotation holding device 504 by the distance “a” in the X direction towards the measurement position MP. In the example of FIGS. 20A, 20B, the direction of the notch NT does not coincide with the reference direction, and the center WC of the substrate W does not coincide with the measurement position MP.

In this state, the rotation holding device 504 is rotated by 360° about the rotation axis RA. During the rotation of the substrate W, the controller 510a of FIG. 18 acquires the output signals of the line sensor 505 as the position data. In this case, because a portion that is close to the outer periphery of the substrate W is held by the rotation holding device 504, a position of the outer periphery of the substrate W is moved in a large range. Therefore, the rotation holding device 504 is rotated while the X direction movable portion 502 and the Y direction movable portion 503a move the substrate W in the X and Y directions such that the outer periphery of the substrate W is positioned in a detectable range by the line sensor 505. The controller 510a calculates the rotation direction offset amount θoff, and calculates the X offset amount Xoff and the Y offset amount Yoff of the center WC of the substrate W with respect to the measurement position MP, based on an amount of movement in the X direction and an amount of movement in the Y direction for every rotation of the rotation holding device 504 by a constant angle and the position data that is acquired from the line sensor 505.

Then, the X direction movable portion 502 and the Y direction movable portion 503 are moved such that the X offset amount and the Y offset amount become 0. Thus, the center WC of the substrate W coincides with the measurement position MP. At this time, the rotation holding device 504 may be rotated such that the rotation direction offset amount θoff becomes 0. In this state, the rotation holding device 504 is rotated by 360° about the rotation axis RA, and the controller 510a calculates the rotation direction offset amount θoff, the X offset amount Xoff and the Y offset amount Yoff.

Next, the X direction movable portion 502 and the Y direction movable portion 503 are moved such that the X offset amount and the Y offset amount become 0, and the rotation holding device 504 is rotated such that the rotation direction offset amount θoff becomes 0. Thus, the center WC of the substrate W coincides with the measurement position MP, and the direction of the notch NT coincides with the reference direction.

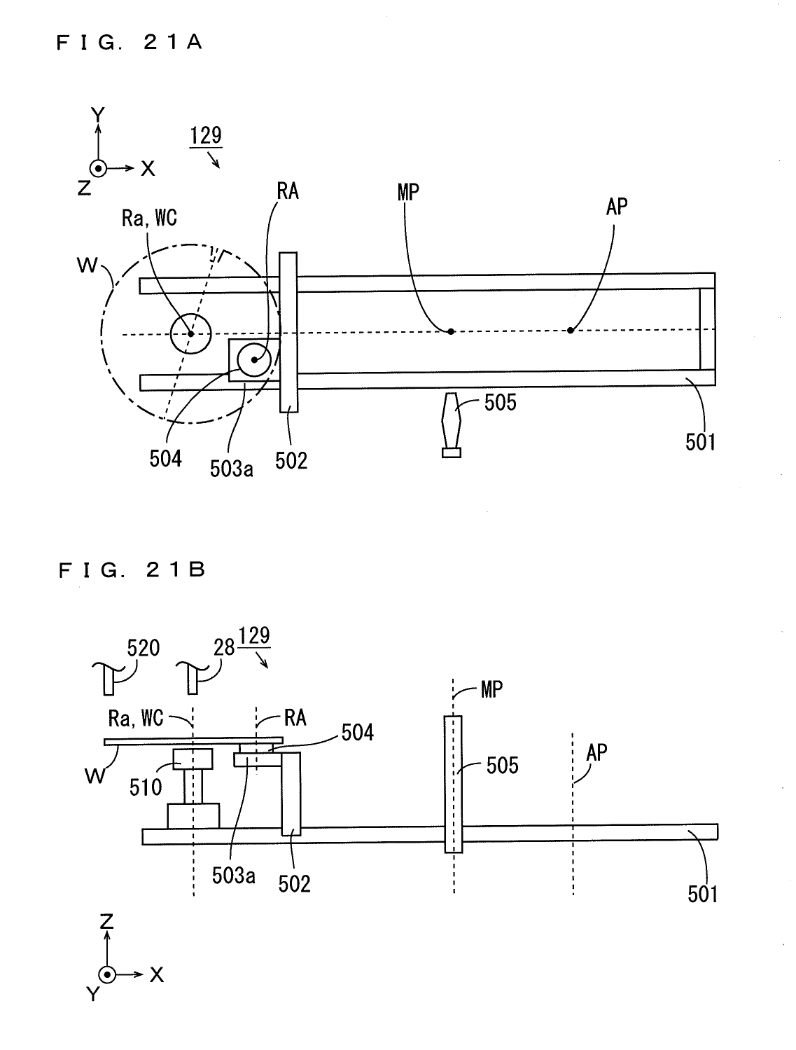

Further, as shown in FIGS. 21A, 21B, the X direction movable portion 502 is moved by the distance “b” in the X direction towards the rotation axis Ra. Thus, the center WC of the substrate W held by the rotation holding device 504 coincides with the rotation axis Ra of the spin chuck 25.

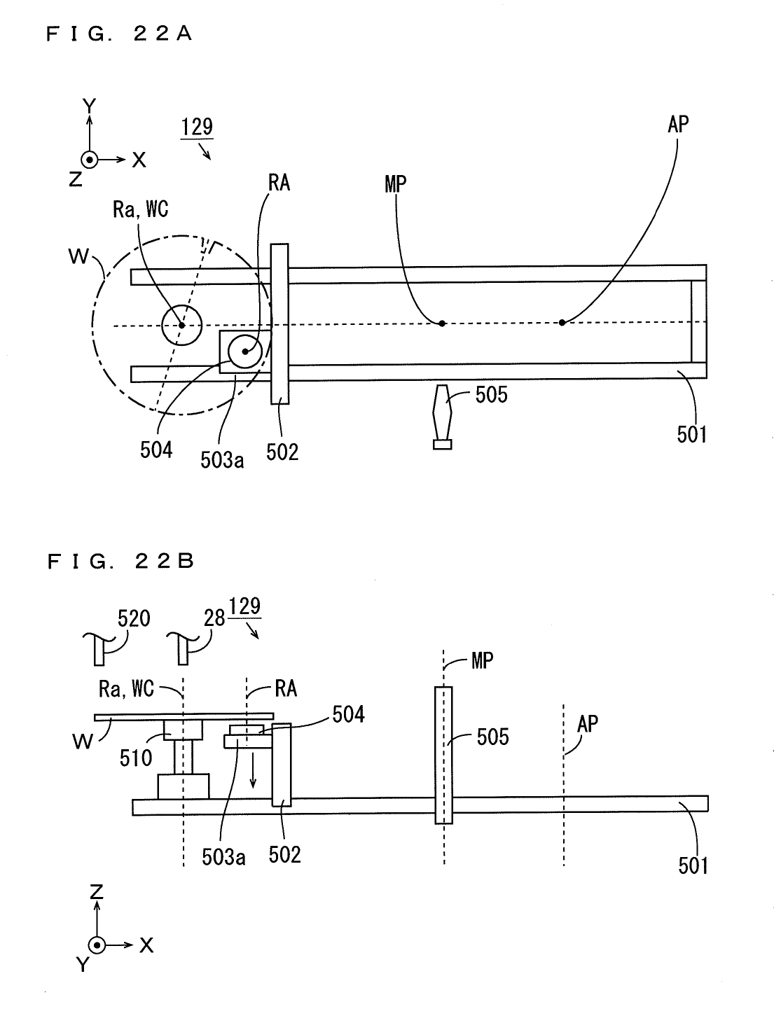

Then, as shown in FIGS. 22A, 22B, the rotation holding device 504 releases the suction of the substrate W, and the Y direction movable portion 503a is moved downward. Thus, the substrate W is placed on the spin chuck 25. Thereafter, the X direction movable portion 502 is moved together with the Y direction movable portion 503a and the rotation holding device 504 in the X direction and returns to the position in the initial state of FIGS. 17A, 17B.

In this state, the spin chuck 25 holds the substrate W by suction and is rotated about the rotation axis Ra. The processing liquid such as the resist liquid is supplied to the upper surface of the rotating substrate W from the processing liquid nozzle 28. Thus, the film such as the resist film is formed on the substrate W. Thereafter, the rinse liquid is supplied to the peripheral portion of the film on the rotating substrate W from the edge rinse nozzle 520. Thus, the peripheral portion of the film on the substrate W is removed.

In the coating processing unit 129 according to the present embodiment, the alignment operation is performed such that the center WC of the substrate W coincides with the rotation axis Ra of the spin chuck 25 and the direction of the notch NT coincides with the reference direction, whereby the uniform film can be formed on the entire upper surface of the substrate W. Further, the edge rinse processing can be accurately performed in the region, having the constant width, at the peripheral portion of the film on the substrate W.
(8) Second Example of Coating Processing Units 129

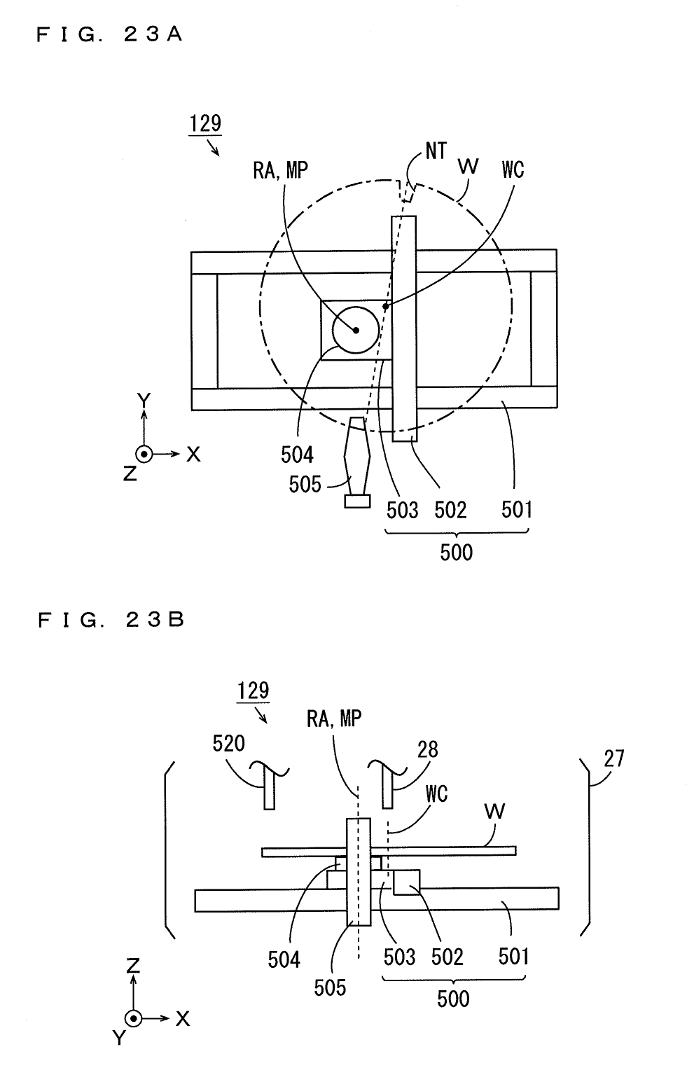

FIGS. 23A, 23B are a schematic plan view and a schematic side view showing a configuration of the second example of each coating processing unit 129.

The configuration of the coating processing unit 129 of FIGS. 23A, 23B is different from the configuration of the coating processing unit 129 of FIGS. 17A, 17B in the following points. In the coating processing unit 129 of FIGS. 23A, 23B, the spin chuck 25 of FIGS. 17A, 17B is not provided. The moving device 500 includes the support member 501, the X direction movable portion 502 and the Y direction movable portion 503 similarly to the moving device 500 of FIGS. 5A, 5B. In the initial state, the rotation axis RA of the rotation holding device 504 is at the measurement point MP.

The hand H1 or the hand H2 of the transport mechanism 127 or the transport mechanism 128 of FIG. 4 places the substrate W on the upper surface of the rotation holding device 504. In the example of FIGS. 23A, 23B, the direction of the notch NT does not coincide with the reference direction, and the center WC of the substrate W does not coincide with the measurement position MP. The rotation holding device 504 sucks the back surface of the substrate W and holds the substrate W in the horizontal attitude.

In this state, the rotation holding device 504 is rotated by 360° about the rotation axis RA. During the rotation of the substrate W, the controller 510a (FIG. 18) acquires the output signals of the line sensor 505 as the position data. The controller 510a calculates the rotation direction offset amount θoff, and calculates the X offset amount Xoff and the Y offset amount Yoff of the center WC of the substrate W with respect to the measurement position MP, based on an amount of movement in the X direction and an amount of movement in the Y direction for every rotation of the rotation holding device 504 by a constant angle and the position data that is acquired from the line sensor 505.

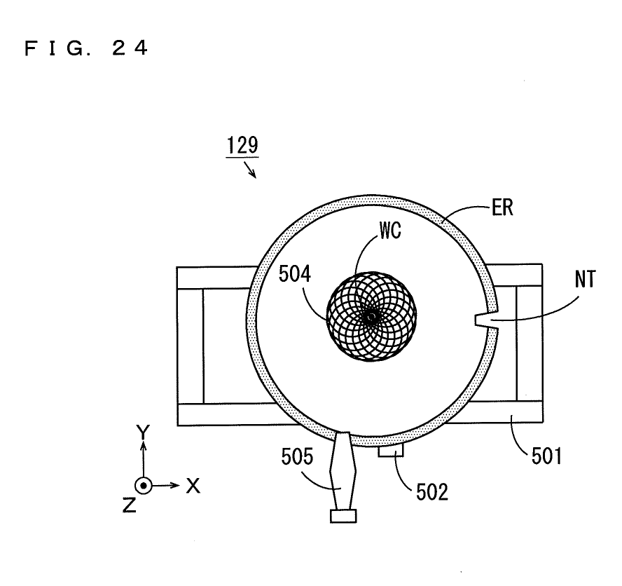

FIG. 24 is a schematic plan view showing an operation of the moving device 500 of the coating processing unit 129 of FIGS. 23A, 23B. As shown in FIG. 24, the controller 510a controls the X direction movable portion 502, the Y direction movable portion 503 and the rotation holding device 504 based on the X offset amount Xoff and the Y offset amount Yoff of the center WC of the substrate W with respect to the measurement position MP such that the substrate W is rotated while the center WC of the substrate W is kept coinciding with the measurement position MP. In this case, the X direction movable portion 502 and the Y direction movable portion 503 move the rotation holding device 504 in the X and Y directions for every rotation of the rotation holding device 504 by a constant angle such that the center WC of the substrate W coincides with the measurement position MP. Thus, the rotation holding device 504 is moved by the XY correction operation as shown in FIG. 24. In FIG. 24, a trajectory of the rotation holding device 504 is drawn by solid lines.

The processing liquid such as the resist liquid is supplied from the processing liquid nozzle 28 to the upper surface of the rotating substrate W. Thus, the film such as the resist film is formed on the substrate W. Thereafter, the rinse liquid is supplied to the peripheral portion of the film on the rotating substrate W from the edge rinse nozzle 520. Thus, the peripheral portion of the film on the substrate W is removed.

In the coating processing unit 129 according to the present embodiment, the substrate W is rotated while the center WC of the substrate W is kept coinciding with the measurement position MP, so that the uniform film can be formed on the entire upper surface of the substrate W. Further, the edge rinse processing can be accurately performed in the region, having the constant width, at the peripheral portion of the film on the substrate W.

### (9) Third Example of Coating Processing Units 129

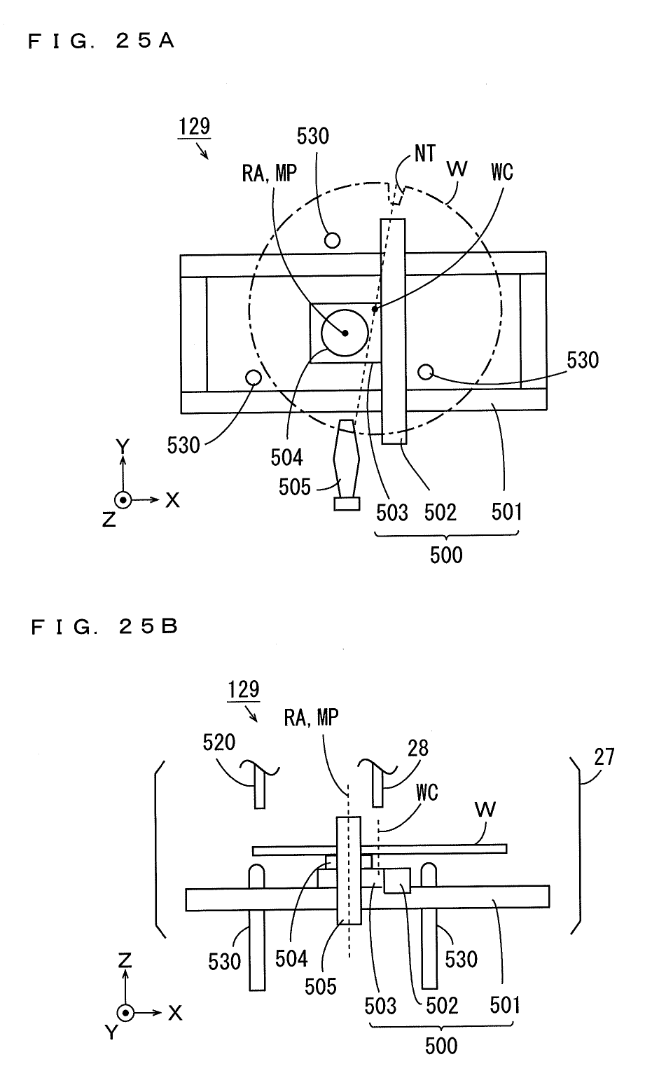

FIGS. 25A, 25B to FIGS. 28A, 28B are schematic plan views and schematic side views showing a configuration and operations of the third example of each coating processing unit 129.

The configuration of the coating processing unit 129 of FIGS. 25A, 25B is different from the configuration of the coating processing unit 129 of FIGS. 23A, 23B in the following point. In the coating processing unit 129 of FIGS. 25A, 25B, more than two lifting pins 530 are further provided.

In the initial state, the lifting pins 530 are spaced apart from the back surface of the substrate W in the downward direction. First, the hand H1 or the hand H2 of the transport mechanism 127 or the transport mechanism 128 of FIG. 4 places the substrate W on the upper surface of the rotation holding device 504. In the example of FIGS. 25A, 25B, the direction of the notch NT does not coincide with the reference direction, and the center WC of the substrate W does not coincide with the measurement position MP. The rotation holding device 504 sucks the back surface of the substrate W and holds the substrate W in the horizontal attitude.

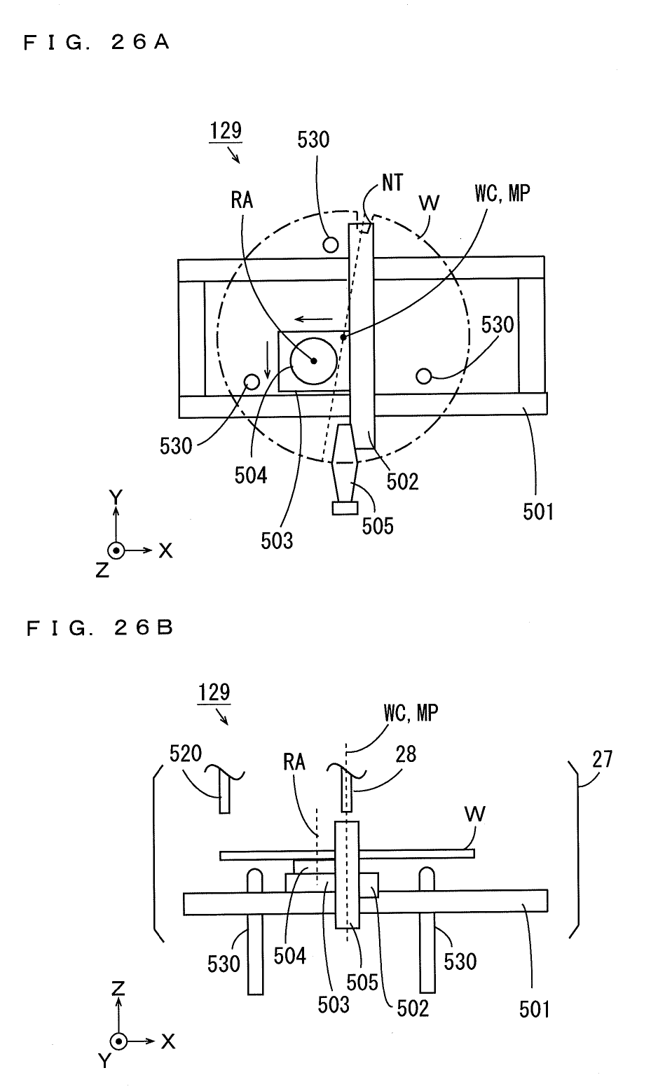

In this state, as shown in FIGS. 26A, 26B, similarly to the coating processing unit 129 of FIGS. 23A, 23B, the rotation direction offset amount θoff, the X offset amount Xoff and the Y offset amount Yoff are calculated based on the position data that is acquired from the line sensor 505. The X direction movable portion 502 and the Y direction movable portion 503 are moved and the rotation holding device 504 is rotated such that the rotation direction offset amount θoff, the X offset amount Xoff and Y offset amount Yoff are 0, respectively. Thus, the center WC of the substrate W coincides with the measurement position MP.

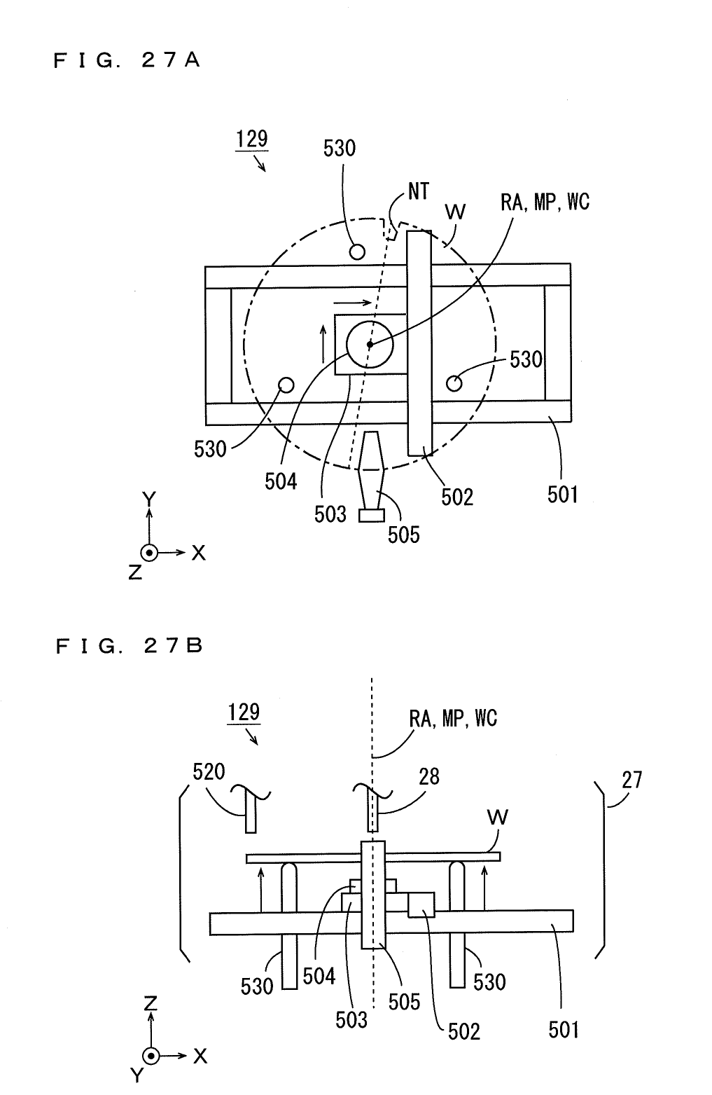

Next, as shown in FIGS. 27A, 27B, the rotation holding device 504 releases the suction of the substrate W, and the lifting pins 530 are lifted. Thus, the substrate W is spaced apart from the rotation holding device 504 and supported above the rotation holding device 504. Thereafter, the X direction movable portion 502 and the Y direction movable portion 503 are moved such that the rotation axis RA of the rotation holding device 504 coincides with the center WC of the substrate W.

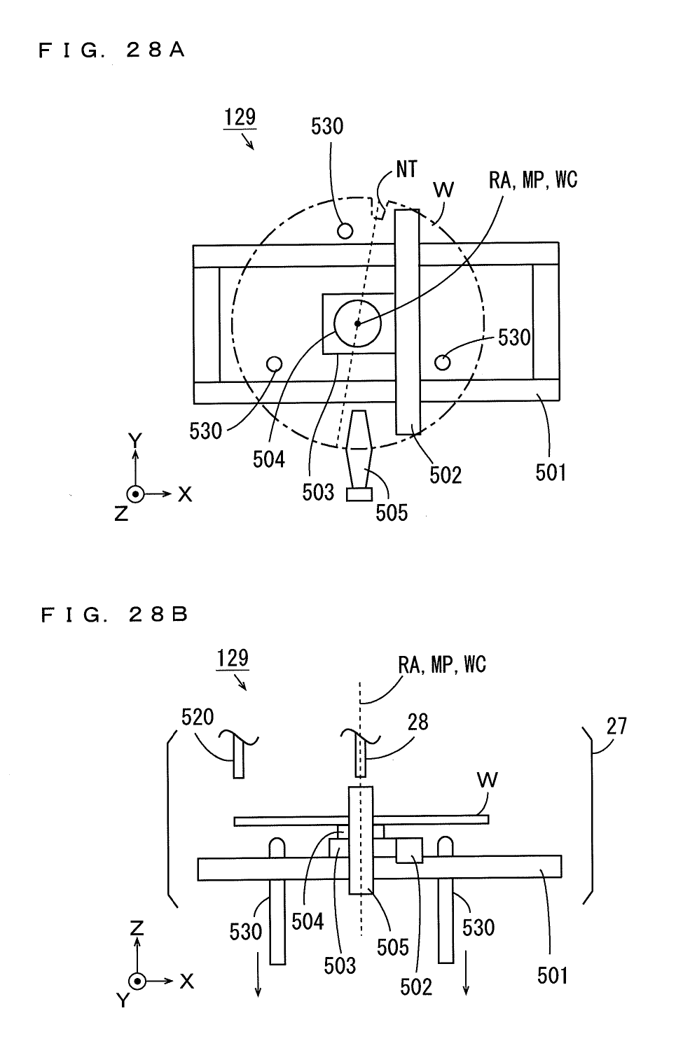

Next, as shown in FIGS. 28A, 28B, the lifting pins 530 are lowered, and the rotation holding device 504 sucks the back surface of the substrate W. Thus, with the center WC of the substrate W coinciding with the rotation axis RA of the rotation holding device 504, the substrate W is held by the rotation holding device 504.

The substrate W is rotated together with the rotation holding device 504, and the processing liquid such as the resist liquid is supplied from the processing liquid nozzle 28 to the upper surface of the rotating substrate W. Thus, the film such as the resist film is formed on the substrate W. Thereafter, the rinse liquid is supplied to the peripheral portion of the film on the rotating substrate W from the edge rinse nozzle 520. Thus, the peripheral portion of the film on the substrate W is removed.

In the coating processing unit 129 according to the present embodiment, because the substrate W is rotated while the center WC of the substrate W is kept coinciding with the rotation axis RA and the measurement position MP, the uniform film can be formed on the entire upper surface of the substrate W. Further, the edge rinse processing can be accurately performed in the region, having the constant width, at the peripheral portion of the film on the substrate W.

### (10) Substrate Platform PASS3

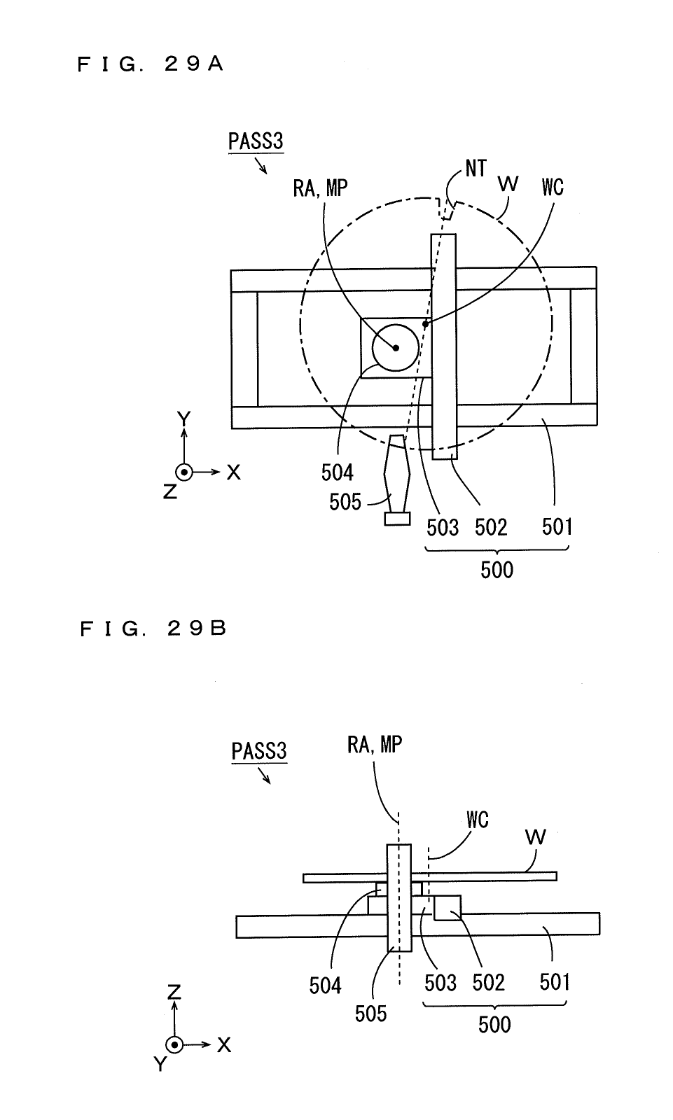

FIGS. 29A, 29B are a schematic plan view and a schematic side view showing a configuration of an example of the substrate platform PASS3. The configurations of the substrate platforms PASS1, PASS2, PASS4 to PASS9 are similar to the configuration of the substrate platform PASS3.

The substrate platform PASS3 of FIGS. 29A, 29B includes the moving device 500, the rotation holding device 504 and the line sensor 505. In the initial state, the rotation axis RA of the rotation holding device 504 is at the measurement position MP. A configuration of a control system of the substrate platform PASS3 is similar to the configuration of the control system of the coating processing unit 129 of FIG. 18 except that the control system of the substrate platform PASS3 does not have the spin chuck 25, the processing liquid supply system 28a or the rinse liquid supply system 520a.

In the substrate platform PASS3 of FIGS. 29A, 29B, the hand 116 of the transport mechanism 115 of FIG. 4 places the substrate W on the upper surface of the rotation holding device 504. In the example of FIGS. 29A, 29B, the center WC of the substrate W does not coincide with the measurement position MP, and the direction of the notch NT of the substrate W does not coincide with the reference direction. The rotation holding device 504 sucks the back surface of the substrate W and holds the substrate W in the horizontal attitude. In this state, the rotation holding device 504 is rotated by 360° about the rotation axis RA, and the controller 510a (FIG. 18) calculates the rotation direction offset amount θoff, the X offset amount Xoff and the Y offset amount Yoff.

Next, the X direction movable portion 502 and the Y direction movable portion 503 are moved such that the X offset amount and the Y offset amount become 0. Thus, the center WC of the substrate W coincides with the measurement position MP. At this time, the rotation holding device 504 may be rotated such that the rotation direction offset amount θoff becomes 0. In this state, the rotation holding device 504 is rotated by 360° about the rotation axis RA, and the controller 510a (FIG. 18) calculates the rotation direction offset amount θoff, the X offset amount Xoff and the Y offset amount Yoff.

Then, the X direction movable portion 502 and the Y direction movable portion 503 are moved such that the X offset amount and the Y offset amount become 0, and the rotation holding device 504 is rotated such that the rotation direction offset amount θoff becomes 0. Thus, the center WC of the substrate W coincides with the measurement position MP, and the direction of the notch NT coincides with the reference direction. Thereafter, the rotation holding device 504 releases the suction of the substrate W.

In this state, the hand H1 or the hand H2 of the transport mechanism 127 or the transport mechanism 128 of FIG. 4 receives the substrate W on the upper surface of the rotation holding device 504 and sequentially transports the substrate W to the adhesion reinforcement processing unit PAHP and the cooling unit CP.

In the substrate platforms PASS1 to PASS9 according to the present embodiment, the direction of the notch NT coincides with the reference direction and the center WC of the substrate W coincides with the measurement position MP, whereby the substrate W can be placed at the same position such that the direction of the notch NT coincides with the constant reference direction in each of the adhesion reinforcement processing unit PAHP, the cooling unit CP and the thermal processing unit PHP. Thus, the plurality of substrates W can be processed under conditions of the same temperature profile.

Further, in a case in which the temperature profiles in the adhesion reinforcement processing unit PAHP, the cooling unit CP, the thermal processing unit PHP are measured using a temperature measurement substrate, when the directions of the notch NT are different from one another, the temperature profiles to be measured are different from one another. The substrate platforms PASS1 to PASS9 according to the present embodiment enables the substrate W to be placed at the same position such that the direction of the notch NT coincides with the constant reference direction in each of the adhesion reinforcement processing unit PAHP, the cooling unit CP and the thermal processing unit PHP. Thus, the temperature profiles can be accurately measured.

The similar configuration to the substrate platform PASS3 of FIGS. 29A, 29B is used for the placement buffer units P-BF1, P-BF2.

### (11) First Example of Cleaning Drying Processing Units SD1

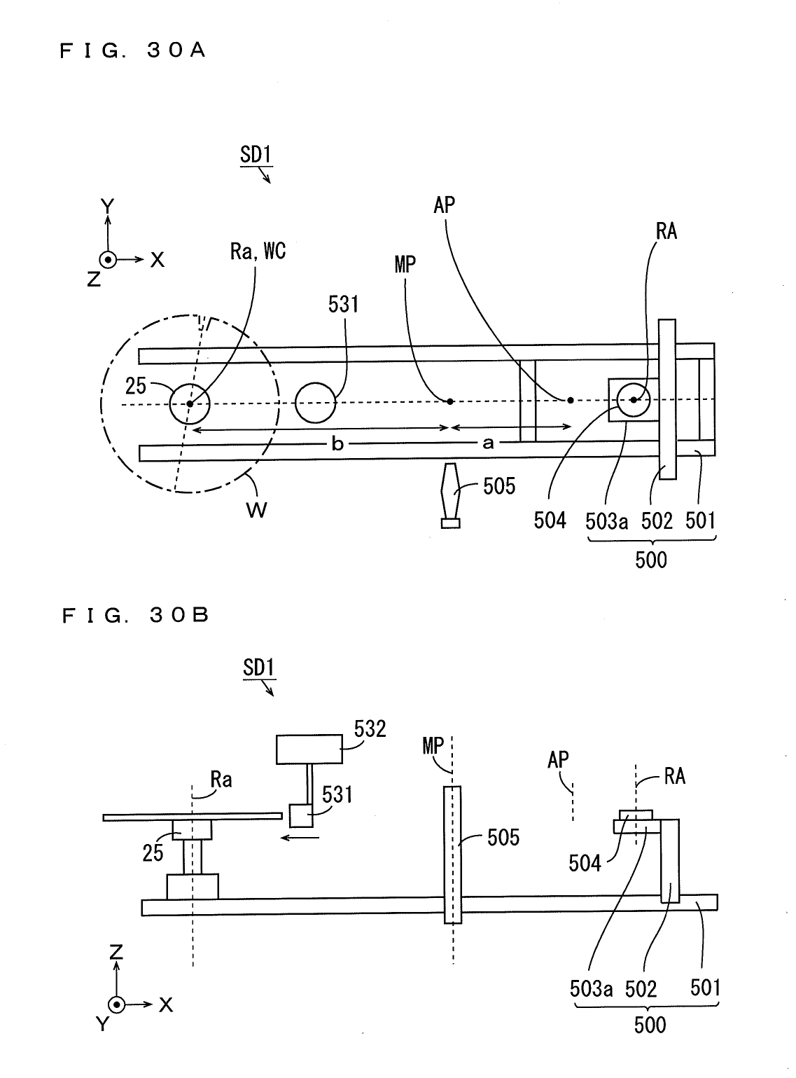

FIGS. 30A, 30B are a schematic plan view and a schematic side view showing a configuration of the first example of each cleaning drying processing unit SDI.

The cleaning drying processing unit SD1 of FIGS. 30A, 30B is used to clean a peripheral end (a bevel portion) of the substrate W. A difference between the cleaning drying processing unit SD1 of FIGS. 30A, 30B and the coating processing unit 129 of FIGS. 7A, 7B is that an end cleaning device 531 and a moving mechanism 532 are provided in the cleaning drying processing unit SD1 of FIGS. 30A, 30B instead of the processing liquid nozzle 28 and the edge rinse nozzle 520. The moving mechanism 532 moves the end cleaning device 531.

The end cleaning device 531 has a housing and a substantially cylindrical brush. The brush is supported in the housing to be rotatable. The housing has an opening into which the outer peripheral end of the substrate W is inserted. A cleaning liquid is supplied to the inside of the housing of the end cleaning device 531. As the cleaning liquid, pure water may be used, pure water in which a complex (an ionized complex) is dissolved may be used, and carbonated water, hydrogen water, electrolytic ionized water or HFE (hydro fluoro ether) may be used, for example.

During end cleaning processing for the substrate W, the moving mechanism 532 moves the end cleaning device 531 to the outer peripheral end of the substrate W. Thus, the outer peripheral end of the substrate W that is rotated by the spin chuck 25 comes into contact with the brush of the end cleaning device 531. Thus, the outer peripheral end of the substrate W is cleaned by the brush. Further, the cleaning liquid is injected in an up-and-down direction towards the outer peripheral end, of the substrate W, with which the brush comes into contact in the housing. Thus, the outer peripheral end of the substrate W is efficiently cleaned.

In the cleaning drying processing unit SD1 according to the present embodiment, the substrate W is placed on the spin chuck 25 by the moving device 500 such that the center WC of the substrate W coincides with the rotation axis RA. Thus, the outer peripheral end of the substrate W can be uniformly cleaned.

### (12) Second Example of Cleaning Drying Processing Units SD1

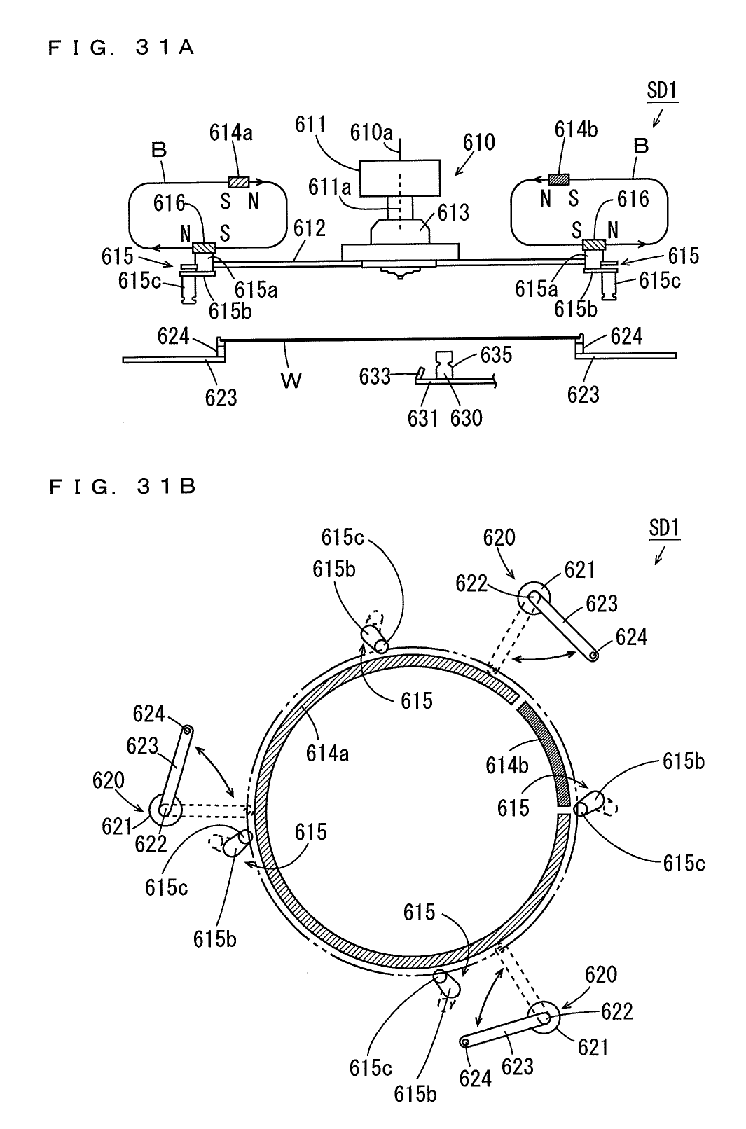

FIGS. 31A, 31B are a schematic side view and a schematic plan view showing a second configuration of each cleaning drying processing unit SD1. Each cleaning drying processing unit SD2 may have the similar configuration to the cleaning drying processing unit SD1 of FIGS. 31A, 31B.

As shown in FIG. 31A, the cleaning drying processing unit SD1 includes a spin chuck 610 that horizontally holds the substrate W and rotates the substrate W about a rotation axis 611a in the vertical direction. The spin chuck 610 includes a spin motor 611, a disc-shape spin plate 612, a plate support member 613, magnet plates 614a, 614b and a plurality of chuck pins 615.

As shown in FIG. 31A, the plate support member 613 is attached to a lower end of a rotation shaft of the spin motor 611. The spin plate 612 is horizontally supported by the plate support member 613. The spin plate 612 is rotated about the rotation axis 611a in the vertical direction by the spin motor 611.

A liquid supply pipe 610a is inserted into the spin motor 611 and the plate support member 613. The cleaning liquid can be supplied to the upper surface of the substrate W held by the spin shuck 610 through the liquid supply pipe 610a. Pure water, for example, is used as the cleaning liquid.

More than three (four in the present example) chuck pins 615 are provided at the peripheral portion of the spin plate 612 about the rotation axis 611a at equal intervals.

Each chuck pin 615 includes a shaft 615a, a pin supporter 615b, a holder 615c and a magnet 616. The shaft 615a is provided to penetrate the spin plate 612, and the pin supporter 615b extending in a horizontal direction is connected to a lower end of the shaft 615a. The holder 615c is provided to project downward from a tip end of the pin supporter 615b. Further, the magnet 616 is attached to an upper end of the shaft 615a above an upper surface of the spin plate 612.

Each chuck pin 615 is rotatable about a vertical axis by being centered at the shaft 615a and can be switched between a close state in which the holder 615c abuts against the outer peripheral end of the substrate W and an open state in which the holder 615c is spaced apart from the outer peripheral end of the substrate W. In the present example, when an N pole of the magnet 616 is on an inner side, each chuck pin 615 is in the close state, and when an S pole of the magnet 616 is on the inner side, each chuck pin 615 is in the open state.

The magnet plates 614a, 614b are arranged above the spin plate 612 in a circumferential direction centered at the rotation shaft 611a. The magnet plates 614a, 614b have S poles on the outer side and N poles on the inner side. The magnet plates 614a, 614b are respectively independently lifted and lowered by a magnet lifting lowering mechanism (not shown) and are moved between an upper position that is higher than the magnet 616 of the chuck pin 615 and a lower position that is substantially at the same height as the magnet 616 of the chuck pin 615. Each chuck pin 615 is switched between the open state and the close state by the lifting and lowering of the magnet plates 614a, 614b as described below.

As shown in FIG. 31A, a cleaning brush 630 for cleaning the outer peripheral end and the back surface of the substrate W held by the spin chuck 610 is provided in a lower portion of the cleaning drying processing unit SD1. The cleaning brush 630 is substantially columnar, and a groove 635 having a V-shape cross section is formed at an outer peripheral surface. The cleaning brush 630 is held by a brush holding member 631. The brush holding member 631 is driven by a brush moving mechanism (not shown), so that the cleaning brush 630 is moved in the horizontal and vertical directions.

A cleaning nozzle 633 is attached to a portion of the brush holding member 631 in the vicinity of the cleaning brush 630. A liquid supply pipe (not shown) to which the cleaning liquid is supplied is connected to the cleaning nozzle 633. A discharge port of the cleaning nozzle 633 is directed to a periphery of the cleaning brush 630, and the cleaning liquid is discharged towards the periphery of the cleaning brush 630 from the discharge port.

As shown in FIG. 31B, more than two (three in the present example) substrate transfer mechanisms 620 are arranged at equal intervals around the rotation axis 611a of the spin chuck 610. Each substrate transfer mechanism 620 includes a lifting lowering rotation driver 621, a rotation shaft 622, an arm 623 and a holding pin 624. The rotation shaft 622 is provided to extend upward from the lifting lowering rotation driver 621, and the arm 623 is coupled to an upper end of the rotation shaft 622 to extend in the horizontal direction. The holding pin 624 for holding the outer peripheral end of the substrate W is provided at a tip end of the arm 623.

The rotation shaft 622 performs a lifting lowering operation and a rotation operation by the lifting lowering rotation driver 621. Thus, the holding pin 624 is moved in the horizontal and vertical directions.

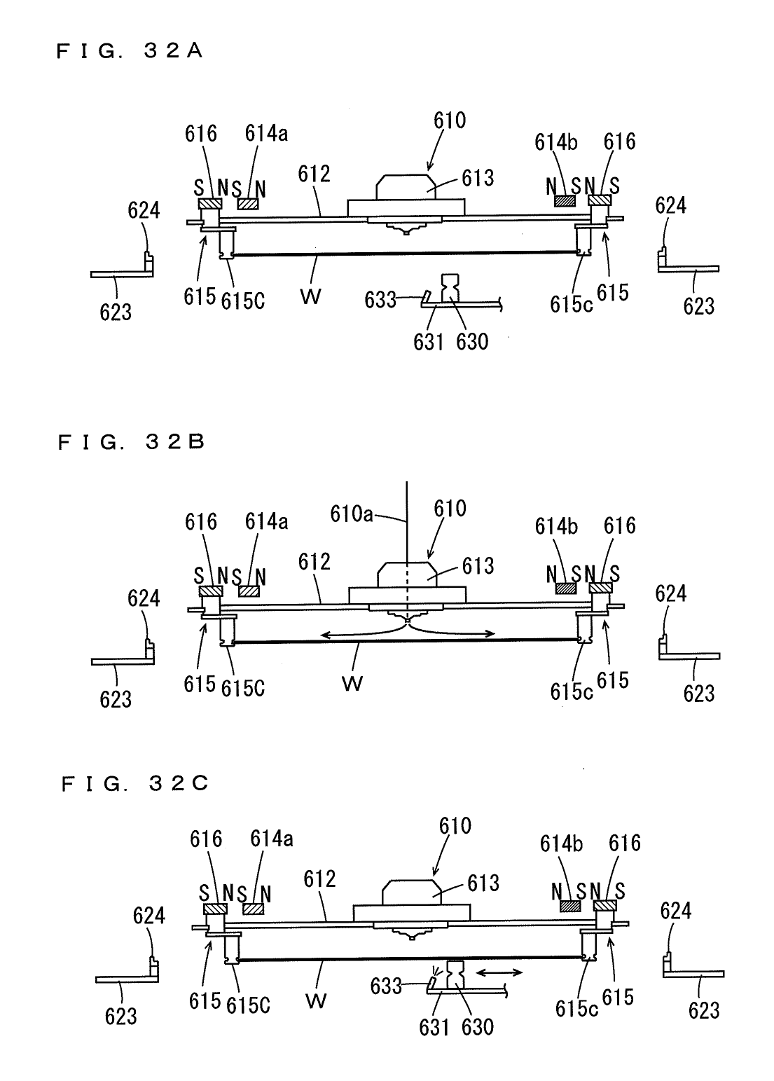

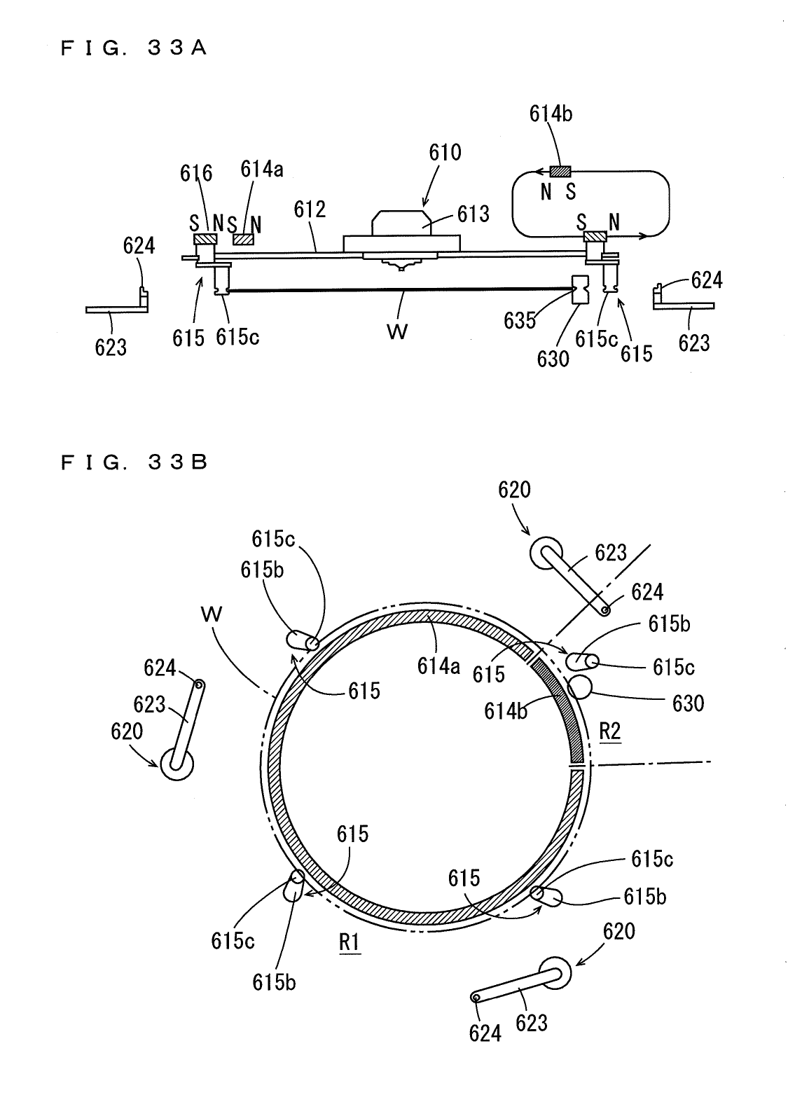

Next, the operation of the cleaning drying processing unit SD1 will be explained with reference to FIGS. 31A to 33B. FIGS. 32A to 33B are schematic views for explaining the operation of the cleaning drying processing unit SD1. FIGS. 32A, 32B, 32C and 33A are schematic cross sectional views, and FIG. 33B is a schematic plan view.

First, as shown in FIG. 31A, the substrate W is placed on the plurality of holding pins 624 by the transport mechanism 141 of FIG. 1.

At this time, the magnet plates 614a, 614b are at the upper positions. In this case, lines of magnetic force B of the magnet plates 614a, 614b are directed outward at the height of the magnets 616 of the chuck pins 615. Thus, the S pole of the magnet 616 of each chuck pin 615 is attracted inward. Therefore, each chuck pin 615 is in the open state. The alignment for the substrate W is performed by the placement buffer unit P-BF1 or the placement buffer unit P-BF2 of FIG. 4 in advance such that the notch NT of the substrate W is not positioned below any one of the plurality of chuck pins 615. Subsequently, the plurality of holding pins 624 are lifted while holding the substrate W. Thus, the substrate W is moved to a position among the holders 615c of the plurality of chuck pins 615.

Then, as shown in FIG. 32A, the magnet plates 614a, 614b are moved to the lower positions. In this case, the N pole of the magnet 616 of each chuck pin 615 is attracted inward. Thus, each chuck pin 615 is in the close state, and the outer peripheral end of the substrate W is held by the holder 615c of each chuck pin 615. Thereafter, the plurality of holding pins 624 are moved outward of a guard 618.

As shown in FIG. 32B, during surface cleaning processing for the substrate W, with the substrate W being rotated by the spin chuck 610, the cleaning liquid is supplied to a surface of the substrate W through the liquid supply pipe 610a. The cleaning liquid spreads across the surface of the substrate W by centrifugal force and is splashed outward. Thus, particles or the like adhering to the surface of the substrate W are cleaned away. Further, part of a component of the film such as the resist film on the substrate W is eluted in the cleaning liquid and cleaned away.

As shown in FIG. 32C, during back surface cleaning processing for the substrate W, with the substrate W being rotated by the spin chuck 610, the cleaning brush 630 is moved to a position below the substrate W. Then, with an upper surface of the cleaning brush 630 being in contact with the back surface of the substrate W, the cleaning brush 630 is moved between a position below the center portion and a position below the peripheral portion of the substrate W. The cleaning liquid is supplied from the cleaning nozzle 633 to a contact portion of the substrate W with the cleaning brush 630. Thus, the entire back surface of the substrate W is cleaned by the cleaning brush 630, and contaminants adhering to the back surface of the substrate W are removed.

As shown in FIGS. 33A, 33B, during the end cleaning processing for the substrate W, the magnet plate 614a is arranged at the lower position, and the magnet plate 614b is arranged at the upper position. In this state, the substrate W is rotated by the spin chuck 610.

In this case, each chuck pin 615 is in the close state in an outer region R1 of the magnetic plate 614a (see FIG. 33B), and each chuck pin 615 is in the open state in an outer region R2 of the magnetic plate 614b (See FIG. 33B). That is, the holder 615c of each chuck pin 615 is kept being in contact with the outer peripheral end of the substrate W when passing through the outer region R1 of the magnetic plate 614a and is spaced apart from the outer peripheral end of the substrate W when passing through the outer region R2 of the magnetic plate 614b.

In the present example, at least the three chuck pins 615 of the four chuck pins 615 are positioned in the outer region R1 of the magnet plate 614a. In this case, the substrate W is held by at least the three chuck pins 615. Thus, stability of the substrate W is ensured.

In this state, the cleaning brush 630 is moved to a position between the holder 615c of the chuck pin 615 and the outer peripheral end of the substrate W in the outer region R2. Then, the groove 635 of the cleaning brush 630 is pressed against the outer peripheral end of the substrate W. The cleaning liquid is supplied from the cleaning nozzle 633 (FIG. 32C) to a contact portion of the cleaning brush 630 with the substrate W. Thus, the entire outer peripheral end of the substrate W is cleaned, and contaminants adhering to the outer peripheral end of the substrate W are removed.

Drying processing for the substrate W is performed after the above-mentioned surface cleaning processing, back surface cleaning processing and end cleaning processing. In this case, the magnet plates 614a, 615b are arranged at the lower positions, and the substrate W is held by all of the chuck pins 615. In this state, the substrate W is rotated at a high speed by the spin chuck 610. Thus, the cleaning liquid adhering to the substrate W is shaken off, so that the substrate W is dried.

In the substrate processing apparatus 100 according to the present embodiment, the alignment for the substrate W is performed by the placement buffer unit P-BF1 or the placement buffer unit P-BF2 of FIG. 4 such that the direction of the notch NT coincides with the constant reference direction. Therefore, it is possible to prevent any one of the chuck pins 615 from being positioned at a portion of the notch NT. Thus, at least the four chuck pins 615 are used, so that the substrate W can be reliably held.

### (13) Another Example of Rotation Holding Device

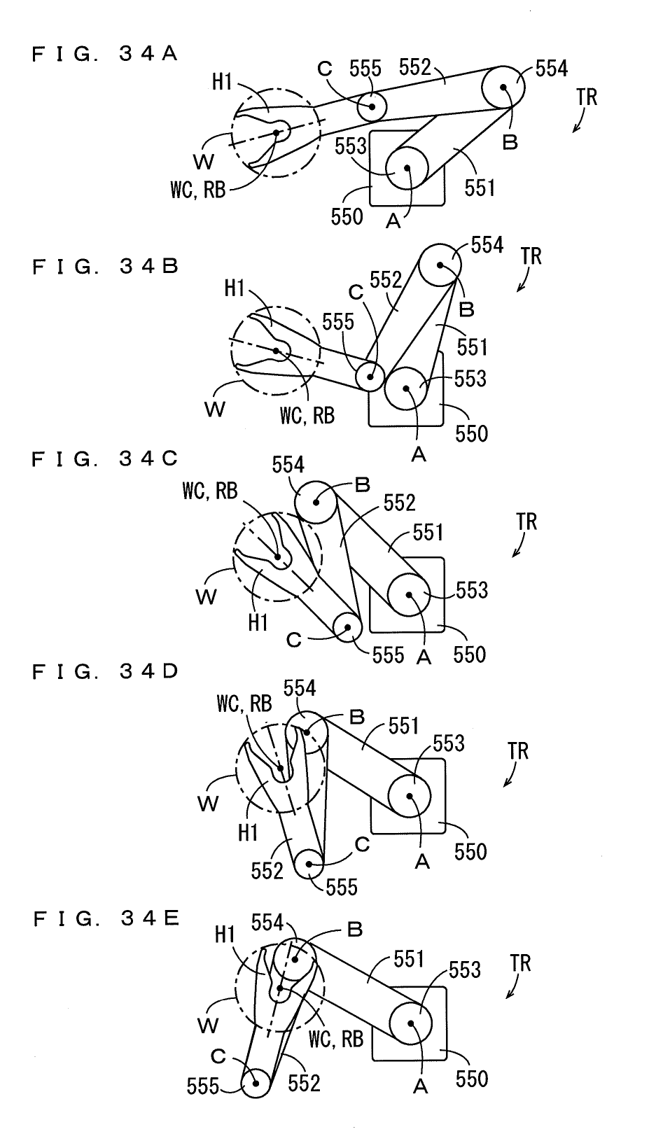

A transport mechanism may be used instead of the moving device 500 according to the above-mentioned embodiment. FIGS. 34A to 34E are schematic plan views showing a configuration and an operation of a main portion of the transport mechanism that is used as the moving device.

The transport mechanism TR shown in FIGS. 34A to 34E includes a rotation driver 550, a first arm 551, a second arm 552 and a hand H1.

One end of the first arm 551 is connected to the rotation driver 550 by a first joint 553. One end of the second arm 552 is connected to the other end of the first arm 551 by a second joint 554. The hand H1 is connected to the other end of the second arm 552 by a third joint 555. The rotation driver 550 is provided to be movable in the X and Y directions.

The first joint 553 is provided on the rotation driver 550. The first joint 553 rotates the first arm 551 about a rotation axis A in the vertical direction with respect to the rotation driver 550. The second joint 554 rotates the second arm 552 about a rotation axis B in the vertical direction with respect to the first arm 551. The third joint 555 rotates the hand H1 about a rotation axis C in the vertical direction with respect to the second arm 552. The hand H1 sucks the back surface of the substrate W and hold the substrate W. A holding position RB is set in the hand H1.

As shown in FIGS. 34A to 34E, the first joint 553 rotates the first arm 551 with respect to the rotation driver 550 with a position of the rotation axis A being fixed. Further, with the holding position RB of the hand H1 being fixed, the second joint 554 and the third joint 555 rotate the second arm 552 and the hand H1 such that the rotation axis C of the third joint 555 draws a circle centered at the holding position RB of the hand H1. Further, also when the center WC of the substrate W deviates from with the holding position RB, the substrate W can be rotated with the center WC of the substrate W coinciding with a predetermined reference axis.

Therefore, the transport mechanism TR of FIGS. 34A to 34E is used instead of each of the transport mechanisms 127, 128, 137, 138, 141, 142, 146 of FIG. 1, whereby the transport mechanism TR can be used instead of the moving device 500 in the above-mentioned embodiment. In this case, the transport mechanism TR that transports the substrate W can also have the function of the moving device 500.

### (14) Example of Encoder

An encoder and a counter are used in order to detect a position of the rotation axis RA in the moving device 500. There are an absolute encoder and an incremental encoder as the encoder. When the absolute encoder is used, a position of the rotation axis RA with an origin position being used as a reference can always be detected. However, the absolute encoder is higher in cost than the incremental encoder. On the other hand, when the incremental encoder is used, an amount of movement of the rotation axis RA can be detected. However, when a supply of a power voltage to the incremental encoder and the counter is stopped, information indicating the position of the rotation axis RA is lost. In this case, a position of the rotation axis RA when the power voltage is supplied again becomes the origin position. Thus, an origin position of a fixed coordinate system of the substrate processing apparatus 100 deviates from an origin position of a coordinate system of the moving device 500.

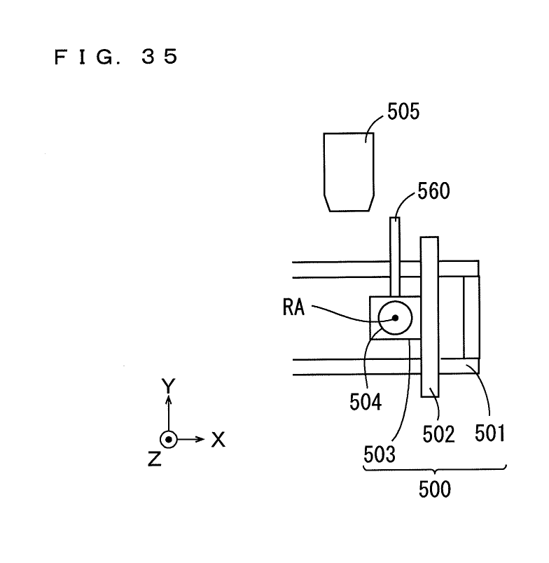

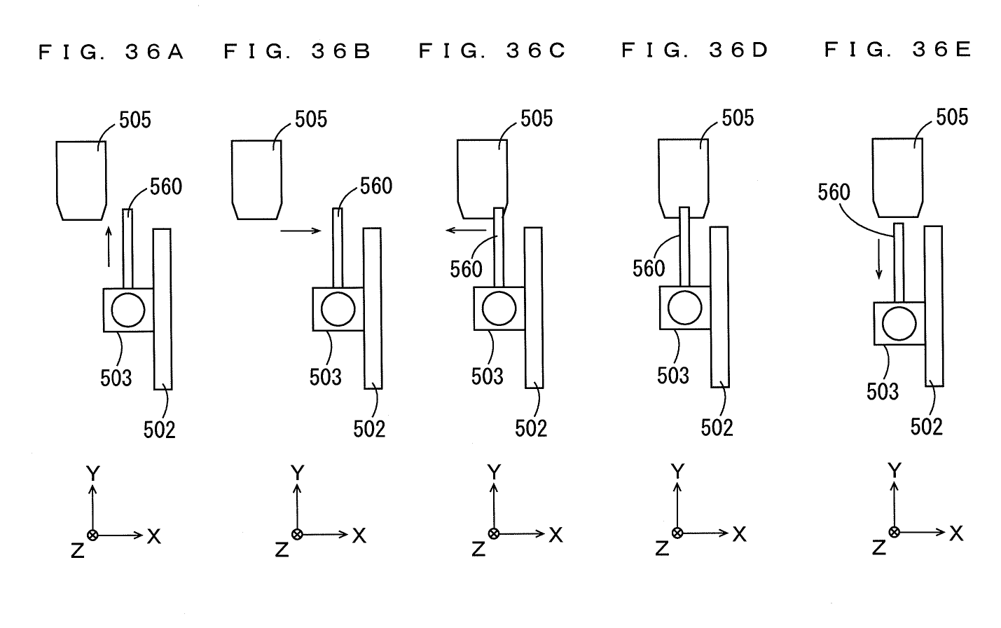

FIG. 35 is a schematic plan view showing a configuration for adjusting the origin position when the incremental encoder is used. FIGS. 36A to 36E are schematic plan views for explaining an adjustment method of the origin position when the incremental encoder is used. In FIGS. 36A to 36E, only part of the moving device 500 is shown.

As shown in FIG. 35, a sector 560 extending in the Y direction is attached to the Y direction movable portion 503. First, as shown in FIG. 36A, the Y direction movable portion 503 is moved together with the sector 560 in the Y direction. Next, as shown in FIG. 36B, the X direction movable portion 502 is moved in the X direction together with the Y direction movable portion 503 and the sector 560 away from the line sensor 505. At this time, a value in the X direction (hereinafter referred to as an X coordinate) and a value in the Y direction (hereinafter referred to as a Y coordinate) that are acquired by the counter are reset to 0.

Next, as shown in FIG. 36C, the X direction movable portion 502 is moved in the X direction together with the Y direction movable portion 503 and the sector 560 to pass through the line sensor 505. Letting a value of the counter at a time point at which the sector 560 is first detected by the line sensor 505 be Y1. Further, letting a value of the counter at a time point at which the sector 560 is finally detected by the line sensor 505 be Y2.

Next, as shown in FIG. 36D, the X direction movable portion 502 is moved together with the Y direction movable portion 503 and the sector 560 such that the sector 560 is positioned at a position at which the value of the counter is (Y1+Y2)/2 (a center of the line sensor 505). At this time, the X coordinate of the counter is reset to 0.

Then, as shown in FIG. 36E, the Y direction movable portion 503 is moved together with the sector 560 in the Y direction away from the line sensor 505. When a position of an end, of the sector 560, that is detected by the line sensor 505 coincides with a predetermined position, the Y coordinate of the counter is reset to 0. A position of the rotation axis RA at this time point is determined as the origin position of the moving device 500. Alternatively, the X direction movable portion 502 and the Y direction movable portion 503 may be further moved by a predetermined distance in the X and Y directions, and the X and Y coordinates of the counter may be reset to 0. In this case, a position of the rotation axis RA after the movement is determined as the origin position of the moving device 500.

### (15) Effects

In the edge exposure unit EEW of FIGS. 5A, 5B of the substrate processing apparatus 100 according to the present embodiment, even when the center WC of the substrate W that is placed on the rotation holding device 504 does not coincide with the rotation axis RA and the direction of the notch NT of the substrate W does not coincide with the reference direction, the rotation holding device 504 is moved such that the center WC of the substrate W coincides with the measurement position MP and the direction of the notch NT of the substrate W coincides with the reference direction. Thus, the film thickness at the predetermined position of the substrate W can be measured, and the edge exposure can be accurately performed in the region, having the constant width, at the peripheral portion of the film on the substrate W.

Further, in the coating processing unit 129 of FIGS. 17A, 17B, even when the center WC of the substrate W that is placed on the rotation holding device 504 does not coincide with the rotation axis RA, the substrate W is transferred from the rotation holding device 504 to the spin chuck 25 such that the center WC of the substrate W coincides with the rotation axis Ra of the spin chuck 25. Thus, the film can be uniformly formed on the substrate W, and the edge rinse processing can be accurately performed in the region, having the constant width, at the peripheral portion of the film on the substrate W.

Further, in the coating processing unit 129 of FIGS. 23A, 23B, 25A, 25B, even when the center WC of the substrate W that is placed on the rotation holding device 504 does not coincide with the rotation axis RA, the substrate W is rotated with the center WC of the substrate W coinciding with the measurement position MP. Thus, the film can be uniformly formed on the substrate W, and the edge rinse processing can be accurately performed in the region, having the constant width, at the peripheral portion of the film on the substrate W.

Further, in the substrate platform PASS3 of FIGS. 29A, 29B, even when the center WC of the substrate W that is placed on the rotation holding device 504 does not coincide with the rotation axis RA and the direction of the notch NT of the substrate W does not coincide with the reference direction, the rotation holding device 504 is moved such that the center WC of the substrate W coincides with the measurement position MP and the direction of the notch NT of the substrate W coincides with the reference direction. Thus, in the substrate platform PASS3, the position of the substrate W can be corrected to the constant position, and the direction of the notch NT of the substrate W can be corrected to the constant reference direction.

Further, in the cleaning drying processing unit SD1 of FIGS. 30A, 30B, even when the center WC of the substrate W that is placed on the rotation holding device 504 does not coincide with the rotation axis RA, the substrate W is rotated with the center WC of the substrate W coinciding with the measurement position MP. Thus, the outer peripheral end of the substrate W can be uniformly cleaned.

### (16) Other Embodiments

(a) In the substrate processing apparatus 100 according to the present embodiment, one or a plurality of any mechanisms of the edge exposure unit EEW of FIGS. 5A, 5B, the coating processing unit 129 of FIGS. 17A, 17B, the coating processing unit 129 of FIGS. 23A, 23B, the coating processing unit 129 of FIGS. 25A, 25B, the substrate platform PASS3 of FIGS. 29A, 29B and the cleaning drying processing unit SDI of FIGS. 30A, 30B, which are the mechanisms for alignment, may be provided.

(b) The mechanism for alignment in the edge exposure unit EEW of FIGS. 5A, 5B may be provided in the coating processing unit 129, the substrate platforms PASS1 to PASS9, the cleaning drying processing units SD1, SD2 or another portion.

(c) The mechanism for alignment in the coating processing unit 129 of FIGS. 17A, 17B may be provided in the edge exposure unit EEW, the substrate platforms PASS1 to PASS9, the cleaning drying processing units SDI, SD2 or another portion.

(d) The mechanism for alignment in the coating processing unit 129 of FIGS. 23A, 23B or FIGS. 25A, 25B may be provided in the edge exposure unit EEW, the substrate platforms PASS1 to PASS9, the cleaning drying processing units SD1, SD2 or another portion.

(e) The mechanism for alignment in the substrate platform PASS3 of FIGS. 29A, 29B may be provided in another portion.

(f) The mechanism for alignment as described in FIGS. 30A, 30B may be provided in a substrate processing apparatus that supplies an etching liquid to the outer peripheral end (the bevel portion) of the substrate W and performs bevel etching for the substrate W.

### (17) Correspondences between Constituent Elements in Claims and Parts in Preferred Embodiments

In the following paragraphs, non-limiting examples of correspondences between various elements recited in the claims below and those described above with respect to various preferred embodiments of the present invention are explained.

In the above-mentioned embodiment, the rotation holding devices 504, 504a are examples of a rotation holding device, the moving device 500 is an example of a moving device, the line sensor 505 is an example of a position detector and the controllers 510, 510a are examples of a controller. Further, the rotation axis RA is an example of a rotation axis, the measurement position MP, the reference axis RR or the rotation axis Ra is an example of a reference axis, the X offset amount Xoff and the Y offset amount Yoff are examples of an amount of deviation, the Y direction is an example of a reference direction and the measurement position MP is an example of a measurement position. Further, the lifting pin 530 is an example of a lifting lowering mechanism, the edge exposure unit EEW or the coating processing unit 129 is an example of a first processor, the cleaning drying processing unit SD1 is an example of a second processor, the film thickness measurement device 507 is an example of a measurement device, the spin chuck 25 is an example of a substrate holder and the assumption position AP is an example of an assumption position.

As each of constituent elements recited in the claims, various other elements having configurations or functions described in the claims can be also used.

While preferred embodiments of the present invention have been described above, it is to be understood that variations and modifications will be apparent to those skilled in the art without departing the scope and spirit of the present invention. The scope of the present invention, therefore, is to be determined solely by the following claims.

### INDUSTRIAL APPLICABILITY

The present invention can be effectively utilized for processing various types of substrates.

I/we claim:

1. A substrate processing apparatus that performs processing on a substrate, comprising:
a rotation holding device that holds the substrate and rotates the substrate about a rotation axis;
a moving device that moves the rotation holding device in a two-dimensional direction that is orthogonal to the rotation axis;
a position detector that detects a position of an outer periphery of the substrate rotated by the rotation holding device; and
a controller that controls the moving device based on the position detected by the position detector such that a center of the substrate held by the rotation holding device coincides with a predetermined reference axis.

2. The substrate processing apparatus according to claim 1, wherein
the controller calculates an amount of deviation between the center of the substrate held by the rotation holding device and the rotation axis of the rotation holding device based on the position detected by the position detector, and controls the moving device based on the calculated amount of deviation such that the center of the substrate held by the rotation holding device coincides with the reference axis.

3. The substrate processing apparatus according to claim 1, wherein
the controller calculates a direction of a notch of the substrate held by the rotation holding device based on the position detected by the position detector, and controls the rotation holding device and the moving device based on the calculated direction such that the direction of the notch of the substrate held by the rotation holding device coincides with a predetermined reference direction.

4. The substrate processing apparatus according to claim 1, wherein
the controller controls the moving device based on the calculated amount of deviation such that the center of the substrate held by the rotation holding device coincides with a predetermined measurement position, controls the rotation holding device and the moving device such that the substrate is rotated with the center of the substrate held by the rotation holding device coinciding with the measurement position, calculates a direction of a notch of the substrate with the center of the substrate coinciding with the measurement position based on the position detected by the position detector, and controls the rotation holding device and the moving device based on the calculated direction such that the direction of the notch of the substrate held by the rotation holding device coincides with a predetermined reference direction.

5. The substrate processing apparatus according to claim 1, wherein
the controller controls the rotation holding device and the moving device such that the rotation holding device rotates the substrate about the rotation axis while the moving device moves the rotation holding device to keep the center of the rotated substrate coinciding with the reference axis.

6. The substrate processing apparatus according to claim 1, further comprising a lifting lowering mechanism that moves the substrate away from the rotation holding device to support the substrate above the rotation holding device after the center of the substrate held by the rotation holding device coincides with the reference axis, wherein
the controller controls the moving device such that the rotation axis of the rotation holding device coincides with the center of the substrate when the substrate is supported by the lifting lowering mechanism,
the lifting lowering mechanism lowers the substrate after the rotation axis of the rotation holding device coincides with the center of the substrate, and
the rotation holding device holds the substrate that is lowered by the lifting lowering mechanism and rotates the substrate about the rotation axis.

7. The substrate processing apparatus according to claim 5, further comprising a first processor that performs processing on a peripheral portion of an upper surface of the substrate rotated by the rotation holding device.

8. The substrate processing apparatus according to claim 5, further comprising a second processor that performs processing on an outer peripheral end of the substrate rotated by the rotation holding device.

9. The substrate processing apparatus according to claim 5, further comprising a measurement device that measures a condition at a predetermined position of the substrate, wherein
the controller moves the substrate held by the rotation holding device by controlling at least one of the rotation holding device and the moving device after the center of the substrate held by the rotation holding device coincides with the reference axis such that the condition at the predetermined position is measured by the measurement device.

10. A substrate processing apparatus that performs processing on a substrate, comprising:
a rotation holding device that holds the substrate in a horizontal attitude and rotates the substrate about a rotation axis;
a transport mechanism that transports the substrate to the rotation holding device such that a center of the substrate deviates from the rotation axis of the rotation holding device;
a moving device that moves the rotation holding device in a two-dimensional direction that is orthogonal to the rotation axis;
a position detector that detects a position of an outer periphery of the substrate rotated by the rotation holding device;
a substrate holder that holds the substrate in the horizontal attitude and has a reference axis in a vertical direction; and
a controller that controls the moving device and the rotation holding device such that the rotation holding device transfers the substrate to the substrate holder, wherein
the controller controls the rotation holding device and the moving device based on the position detected by the position detector such that the center of the transferred substrate coincides with the reference axis of the substrate holder.

11. The substrate processing apparatus according to claim 10, wherein
an assumption position that deviates from the rotation axis of the rotation holding device is set in advance, and
the controller calculates an amount of deviation between the center of the substrate held by the rotation holding device and the assumption position based on the position detected by the position detector, and controls the moving device based on the calculated amount of deviation such that the center of the transferred substrate coincides with the reference axis of the substrate holder.

12. The substrate processing apparatus according to claim 10, wherein
the controller calculates a direction of a notch of the substrate held by the rotation holding device based on the position detected by the position detector, and controls the rotation holding device and the moving device based on the calculated direction such that the direction of the notch of the transferred substrate coincides with a predetermined reference direction.

13. The substrate processing apparatus according to claim 10, wherein
the substrate holder is configured to hold the substrate in the horizontal attitude and rotate the substrate about the reference axis.

14. The substrate processing apparatus according to claim 13, further comprising a first processor that performs processing on a peripheral portion of an upper surface of the substrate rotated by the substrate holder.

15. The substrate processing apparatus according to claim 13, further comprising a second processor that performs processing on an outer peripheral end of the substrate rotated by the substrate holder.

16. A substrate processing method for performing processing on a substrate, including the steps of:
holding and rotating the substrate about a rotation axis by a rotation holding device;
detecting a position of an outer periphery of the substrate rotated by the rotation holding device; and
moving the rotation holding device in a two-dimensional direction that is orthogonal to the rotation axis based on the detected position such that a center of the substrate held by the rotation holding device coincides with a predetermined reference axis.

17. A substrate processing method for performing processing on a substrate, including the steps of:
transporting the substrate to a rotation holding device by a transport mechanism such that a center of the substrate deviates from a rotation axis of the rotation holding device;
holding the substrate in a horizontal attitude and rotating the substrate about the rotation axis by the rotation holding device;
detecting a position of an outer periphery of the substrate rotated by the rotation holding device;
transferring the substrate from the rotation holding device to the substrate holder; and
holding the transferred substrate in the horizontal attitude by the substrate holder, wherein
the step of transferring includes moving the rotation holding device in a two-dimensional direction that is orthogonal to the rotation axis by a moving device based on the detected position such that the center of the transferred substrate coincides with the reference axis of the substrate holder.
